(19) United States
(12) Patent Application Publication
(10) Pub. No.: US 2024/0373287 A1
(43) Pub. Date: Nov. 7, 2024

(54) Capacity Monitor For Cross-Layer Cellular Protocol

(71) Applicant: The Trustees of Princeton University, Princeton, NJ (US)

(72) Inventors: Kyle Jamieson, Princeton, NJ (US); Yaxiong Xie, Princeton, NJ (US)

(21) Appl. No.: 18/684,968

(22) PCT Filed: Aug. 19, 2022
(86) PCT No.: PCT/US2022/075224

§ 371 Date: Feb. 20, 2024

Related U.S. Application Data
(60) Provisional application No. 63/235,248, filed on Aug. 20, 2021.

(51) Int. Cl. H04W 28/02; H04L 1/00

(52) U.S. Cl. CPC H04W 28/0289; H04L 1/0061

(57) ABSTRACT

Embodiments are directed to a telemetry tool that can decode all of the control messages included in a signal. The tool uses the decoded control messages in conjunction with packet statistics and other information to derive knowledge regarding network capacity, including during carrier aggregation. The tool locates and decodes the control messages within a control channel and uses a set of validation methods to ensure the control messages are decoded correctly. The tool provides valuable information that can be used to improve network efficiency and function and allow user devices to take advantage of all of a network's available bandwidth.

### RELATED APPLICATION

This application claims the benefit of U.S. Provisional Application No. 63/235,248, filed on Aug. 20, 2021. The entire teachings of the above application are incorporated herein by reference.

### GOVERNMENT SUPPORT

This invention was made with government support under Grant No. CNS-1617161 awarded by the National Science Foundation. The government has certain rights in the invention.

### BACKGROUND

As cellular networks expand, methods and applications of wireless communication have become increasingly essential to modern life. To improve efficiency and coverage, multiple end user devices receive data from a singular cellular signal. However, when a single cellular and/or wireless broadcasting source, such as a base station or cell, is shared across multiple independent devices, each device lacks the complete information about how the cellular and/or wireless broadcasting source is being utilized. This leads to inefficiencies. For example, excess cellular signal capacity may exist but, no device is made aware of this fact or is able to utilize the excess because the devices lack knowledge about the use of the cellular signal by other devices.

### SUMMARY

As such, a need exists for a device receiving a cellular signal to gain information regarding properties of the cellular signal and the use of that cellular signal by other devices. Embodiments provide such functionality.

Accurate and highly-granular channel capacity telemetry of the cellular last hop is crucial for the effective operation of transport layer protocols and cutting-edge applications, such as video on demand and video telephony. Embodiments of the invention disclosed herein, which may be referred to herein as “NG-Scope,” include the designs, implementations, and methods of use, as well as experimental performance evaluation of NG-Scope. NG-Scope is a telemetry tool that fuses physical-layer channel occupancy readings from the cellular control channel with higher-layer packet arrival statistics to make accurate capacity estimates. NG-Scope is capable of providing cellular capacity measurements when multiple base stations aggregate their signals together to serve mobile users. End-to-end experiments in a commercial cellular network demonstrate that wireless capacity varies significantly with channel quality, mobility, competing traffic within each cell, and the number of aggregated cells. Example embodiments demonstrate significantly improved cell load estimation accuracy, missing the detection of less than 1% of data capacity overall, a reduction of 82% compared to Online Watcher for LTE (“OWL” described in N. Bui and J. Widmer. OWL: A reliable online watcher for LTE control channel measurements. In ACM AllThingsCellular, 2016), the state-of-the-art in cellular monitoring. Further data provided by example embodiments show that MobileInsight-based (described in Y. Li, C. Peng, Z. Yuan, J. Li, H. Deng, and T. Wang. Mobileinsight: Extracting and analyzing cellular network information on smartphones. In ACM MobiCom, 2016). CLAW (described in X. Xie, X. Zhang, and S. Zhu. Accelerating mobile web loading using cellular link information. In ACM MobiSys, 2017.) has a root-mean-squared capacity error of 30.5 Mbit/s, which is 3.3× larger than NG-Scope (9.2 Mbit/s).

An embodiment is directed to a computer-implemented method to identify network properties. Such a method receives, at a computing device, a cellular signal including one or more control messages formed by a plurality of control channel elements, wherein each control message is formed of one or more of the plurality of control channel elements and each control message is encoded using a function, a respective associated cyclic redundancy check, and a respective unknown temporary identifier. In turn, for each control message, the method identifies the one or more of the plurality of control channel elements forming the control message and derives, based upon the identified one or more of the plurality of control channel elements, candidate calculated cyclic redundancy checks. The method continues by deriving candidate temporary identifiers using the function, the candidate calculated cyclic redundancy checks, and the respective associated cyclic redundancy check and determining the respective unknown temporary identifier from amongst the derived candidate temporary identifiers. The method concludes by decoding the control message using the function, the determined respective unknown temporary identifier, and the respective associated cyclic redundancy check, wherein the decoded control message indicates network properties.

In some embodiments of the method, the computing device is a primary computing device and the one or more control messages are transmitted to one or more secondary computing device distinct from the primary computing device. Additionally, each respective unknown temporary identifier may be a 16-bit cell radio network temporary identifier. The function may be an exclusive or (XOR) function.

The plurality of control channel elements can be distributed within a control channel comprising a section of the cellular signal. In such embodiments, the plurality of control channel elements can be two-dimensional subsections of the control channel defined by time and frequency.

In some embodiments of the method, identifying the one or more of the plurality of control channel elements forming the control message comprises measuring respective energy of each of the plurality of control channel elements and determining that a control channel element of the plurality of control channel elements with a measured respective energy below a threshold does not form the control message.

In some embodiments of the method, identifying the one or more of the plurality of control channel elements forming the control message comprises organizing the plurality of control channel elements into a binary tree hierarchy. Such an embodiment determines that one or more control channel elements represented by a child node, of a parent node in the binary tree hierarchy, do not form the control message if one or more control channel elements represented by the parent node do not form the control message.

In some embodiments, deriving, based upon the identified one or more of the plurality of control channel elements, the candidate calculated cyclic redundancy checks comprises decoding the control message using the identified one or more of the plurality of control channel elements and calculating the cyclic redundancy checks using the control message decoded.

Determining the respective unknown temporary identifier from amongst the derived candidate temporary identifiers may comprise performing at least one of: child-ancestor matching, temporal user tracking, search space matching, and verifying re-encoded errors.

The network properties can include any network properties known to those of skill in the art. For instance, in an embodiment, the network properties include at least one of: channel quality, allocated channel bandwidth, number of active mobile users, total used bandwidth, and idle bandwidth. The cellular signal can be a Long-Term Evolution (LTE) signal.

Embodiments may further comprise monitoring, using a transport layer of the computing device, the received cellular signal to determine packet statistics of the cellular signal and combining the determined packet statistics and the network properties to determine congestion of the network. In such embodiments, the determined congestion of the network may be reported to an application layer of the computing device. In turn, the application layer may control use of the network by the computing device based on the reported determined congestion.

Another embodiment is directed to a computer based system for identifying network properties. The system comprises a receiver configured to receive, a cellular signal including one or more control messages formed by a plurality of control channel elements, wherein each control message is formed of one or more of the plurality of control channel elements and each control message is encoded using a function, a respective associated cyclic redundancy check, and a respective unknown temporary identifier. The system also includes a processor and a memory with computer code instructions stored thereon. In such an embodiment, the processor and the memory, with the computer code instructions, are configured to cause the system to identify network properties according to any embodiment or combination of embodiments described herein.

Yet another embodiment is directed to a computer program product for identifying network properties. The computer program product comprises one or more non-transitory computer-readable storage devices and program instructions stored on at least one of the one or more storage devices. The program instructions, when loaded and executed by a processor, cause an apparatus associated with the processor to identify network properties according to any embodiment or combination of embodiments described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is simplified block diagram illustrating congestion control methods of the transport layer protocols utilized by existing wireless communication methods.

FIG. 2A is a graph of bandwidth allocation using carrier aggregation.

FIG. 2B is a graph of packet delay illustrating the effect of carrier aggregation shown the graph of FIG. 2A.

FIG. 3A is a diagram illustrating the structure of a Long-Term Evolution (LTE) 1 ms subframe.

FIG. 3B is an illustration of resource allocation between transport blocks of a LTE transmission.

FIG. 4 is a block diagram of the system architecture of an example embodiment.

FIG. 5 is a diagram of an encoding process of a control message that is utilized in embodiments.

FIG. 6 is an illustration of control message distribution inside the control channel.

FIG. 7A is a visual depiction of candidate locations for eight consecutive control channel element (CCE) segments.

FIG. 7B is a visual depiction of a binary tree hierarchy utilized by embodiments of the invention for searching eight consecutive CCE segments.

FIG. 8 is an illustration of a repeated control message with multiple aggregation levels.

FIG. 9 is a diagram of a user equipment (UE) tracker utilized by embodiments.

FIG. 10 is a simplified block diagram illustrating transport block failure and retransmission.

FIG. 11 is a graph of inter-packet-arrival time resulting from packet decoding failure and the resulting packet burst.

FIG. 12 is a diagram of an example experimental implementation of an embodiment.

FIG. 13 illustrates capacity calculation utilizing the example experimental implementation of the embodiment of FIG. 12.

FIG. 14 is a comparison the percentage of control messages that are correctly decoded by an embodiment of the invention and Reliable Online Watcher for LTE Control Channel Measurements (“OWL”).

FIG. 15A is a graph of the percentage of data that is missing from control messages decoded by an embodiment of the invention and OWL.

FIG. 15B is a graph of the false positives detected by an embodiment of the invention and OWL.

FIG. 16A is a graph of the distribution of the time a Viterbi decoder takes to decode 3.8 million control messages transmitted by a 20 MHz base station.

FIG. 16B is a graph of the number of convolutional decoding attempts performed by an embodiment of the invention inside each subframe, when decoding the control channel of a 5, 10, and 20 MHz base station.

FIG. 17A is a set of graphs of a cumulative distribution function (CDF) of the number of active users in a subframe of a base station signal in 72 hours.

FIG. 17B is a graph of central processing unit (CPU) usage versus number of users that the base station of FIG. 17A, serves in 2-minute periods.

FIG. 18 is a set of graphs that plot a tracker Modulation and Coding Scheme (MCS) index that a cell selects for a UE, available PRBs, and calculated LTE link capacity for a static UE and a mobile UE.

FIG. 19A are plots of aggregated capacity of a Samsung Galaxy S8 and a Xiaomi MIX3 mobile devices, respectively, determined using an example embodiment.

FIG. 19B is a graph of LTE physical layer data calculated from a control message decoded using an example embodiment and one-way delay recorded at an UE.

FIG. 20A is a graph of average achieved throughput and 95th percentile one-way delay of eight congestion control algorithms, including a congestion control algorithm that utilizes an example embodiment.

FIG. 20B is a graph showing the effect of a varying number of missing control messages on average achieved throughput and 95th percentile one-way delay achieved with a congestion control algorithm using an example embodiment of the invention.

FIG. 21A is a graph comparing NG-MPC, a model predictive control algorithm utilizing data provided by an embodiment of the invention, with existing adaptive bitrate streaming (ABR) algorithms on the quality of experience metric QoEₗᵢₙ.

FIG. 21B is a graph comparing NG-MPC, a model predictive control algorithm utilizing data provided by an embodiment of the invention, with existing adaptive bitrate streaming (ABR) algorithms on quality of experience metric QoE_{log}.

FIG. 21C is a graph comparing NG-MPC, a model predictive control algorithm utilizing data provided by an embodiment of the invention, with existing adaptive bitrate streaming (ABR) algorithms on quality of experience metric QoE_{HD}.

FIG. 22 is a graph of transport block error rate as a function of offered load and locations of a user.

FIG. 23 is a graph of cumulative distribution functions for size of transport blocks sent to a user with varying offered load.

FIG. 24 is a graph of transport block error rate as a function of transport block size for locations with reference signal received power (RSRP) 98 dBm and 113 dBm.

FIG. 25 is a graph of transport block error rate as a function of offered load for a mobile user for indoor and outdoor user trajectories at varying RSRP ranges.

FIG. 26 is a graph of received data rate from each of three cells and an aggregation of received data rate of the three cells, measured using an embodiment.

FIG. 27A is a plot of bandwidth usage percentage, i.e., a ratio of allocated PRBs to the total amount of PRBs, of a cell as function of offered load.

FIG. 27B is a plot of bandwidth usage percentage of a UE as a function of offered load.

FIG. 28 is a plot of cumulative distribution functions of a modulation coding scheme index each cell of FIGS. 27A-B, uses to transmit data to the UE.

FIG. 29A is a set of graphs showing channel usage of primary (cell 1), secondary (cell 4), and tertiary (cell 5) cells of a Samsung S8 device.

FIG. 29B is a set of graphs showing channel usage of the primary (cell 1) and secondary (cell 3) cells of a Xiaomi MIX3 device.

FIG. 30A is a graph of a cumulative distribution function (CDF) of PRB estimation error for CLAW and an example embodiment of the invention implemented on data received at mobile devices located indoors and outdoors.

FIG. 30B is a graph of a CDF of capacity estimation error for CLAW and an example embodiment of the invention implemented on data received at mobile devices indoors and outdoors.

FIG. 31 is a plot of PRB allocation results of subframes measured by an embodiment.

FIG. 32 is a graph of PRB allocation for a web browsing user over time.

FIG. 33 is a graph of one-way delay as a function of offered load varying from 10 Mbit/s to 70 Mbit/s.

FIG. 34 is a schematic view of a computer network or similar digital processing environment in which embodiments of the present invention may be implemented.

FIG. 35 is a block diagram of the internal structure of a computer (e.g., client processor/device or server computers) in the computer network of FIG. 34.

### DETAILED DESCRIPTION

A description of example embodiments follows.

Cellular traffic has accounted for 72% of global mobile traffic in the past few years and this trend is expected to continue through 2022. Motivated by this, network designers are devoting significant efforts to improve the congestion control design of end-to-end transport protocols, to enable key applications, such as video streaming and video telephony, can work seamlessly with cellular networks, whose channel capacity varies significantly within a very short period of time.

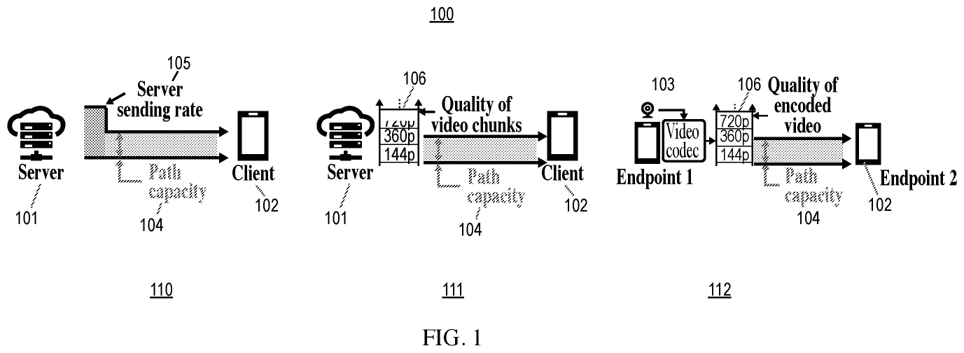

FIG. 1 is an illustration of congestion control algorithms of the transport layer protocols 100 utilized by existing wireless communication methods. A server 101 sends a communication to a client device 102 (also referred to herein as “user equipment” and/or “UE”). Path capacity 104, i.e., the capacity of a Transmission Control Protocol (TCP) connection, is a fundamental system parameter that many end-to-end protocols and applications require as an input. For example, to maximize throughput and minimize delay, modern congestion control algorithms, like Bottleneck Bandwidth and Round-trip propagation time (BBR), Performance-oriented Congestion Control (“PCC”), Copa, and Physical-Layer Bandwidth measurements taken at the Endpoint (PBE), try to match the server 101 sending rate 105 to the path capacity 104. High performance requires accurate and fine-grained estimation of the capacity 104 to ensure that no capacity is idle or underutilized. Diagram 110 shows a congestion control algorithm that matches the server's 101 send rate 105, to the client device 102, to the path capacity 104.

In an example such as video streaming, the server 101 fragments whole transmissions into small chunks, encodes each chunk into multiple bit rates, and adaptively selects the bit rate 106 (and thus resolution) of each chunk. Diagram 111 shows a server 101 that selects the bit rate 106 according to the estimate of the path capacity 104 and buffer occupancy of the user device 102. Diagram 112 shows an example of video telephony. Unlike video streaming 111, which pre-encodes the video into all available bit rates, the video telephony endpoint 103 encodes the video in real time. Endpoints, such as user device 102 and video source 103, use the available path capacity 104 to adjust the encoded video quality 106, minimizing video delivery latency and maximizing user quality of experience (QoE).

One determinant of the end-to-end path capacity 104 is the capacity of the last-(or first-) hop: wireless cellular Radio Access Network (RAN). Estimating and tracking the capacity of a wireless RAN is challenging, since capacity of the wireless RAN varies over millisecond-level time scales for the following three reasons. First, cellular networks adopt orthogonal frequency-division multiple access (OFDMA) to share bandwidth among all mobile users at a subframe (millisecond) granularity. Therefore, the start and termination of any user's data flow can cause abrupt capacity fluctuations. Second, the wireless channel quality between the cell tower and the user varies due to user mobility, multipath propagation, and interference. The highest data rate the cellular wireless channel can support changes accordingly. Third, both 4G LTE and the 5G implement a technique called carrier aggregation (CA), via which, the cellular network aggregates two or more cell towers (herein after called “component carriers” or “cells”) to boost maximum per-user data rates. Because of carrier aggregation, one user is not only affected by the dynamics from one cell, but from all of its aggregated cells.

Because of the dynamic nature of cellular networks, a telemetry tool is needed that is able to provide accurate and millisecond-granular capacity estimation updates for cellular networks. A congestion controller and upper layer applications can adjust system parameters, such as send rate or video resolution, in accordance with the underlying network conditions, e.g., capacity estimations, determined by such a telemetry tool. Examples of this adjustment are illustrated in diagrams 111 and 112 of FIG. 1. With the millisecond-granular capacity updates, the controller and applications can detect network variations with up to millisecond-level delay and, thus, take quick actions to mitigate the impact of such network dynamics. Even if there may exist a delay between the observation of the network variations and the time the actions of the controller or end-to-end applications take effect (the maximum delay is one propagation delay depending on where the observation is taken), the delay is minimized when the action and the observation are taken at the same place and the delay is maximized to one Round-trip time (RTT) if the observation has to be delivered back to the sender. Experimental results, discussed hereinbelow demonstrate that such a timely observation still improves the performance of congestion control and video streaming applications significantly.

Embodiments of the invention, which are directed to an accurate and fine-grained telemetry tool, utilize the following observation: the cell tower broadcasts all the wireless parameters that affect the wireless cellular channel capacity, including the modulation and coding rate (MCS), the number of multiple-input and multiple-output (MIMO) spatial streams, the allocated frequency bandwidth, and the aggregated cell towers, to the mobile users via a physical control channel, every one millisecond. By carefully decoding this physical control channel, embodiments of the invention determine the internal state of the wireless cellular network, i.e., network properties and, in turn, can provide the determined properties to the transport layer and applications at the endpoints. This opens new possibilities for designing agile transport layer protocols and implementing video applications with maximized QoE. Passive cellular sniffers such as LTEye and OWL have some ability to decode the control channel to infer some of the wireless attributes, but these existing sniffers cannot work with the most cutting edge cellular networks that use techniques such as carrier aggregation. Thus, the existing sniffers are not able to track the abrupt capacity changes that carrier aggregation causes. MobileInsight can only analyze the radio resource allocation of a single user, i.e., the mobile device that MobileInsight is implemented on, rather than cell-wide information, which is mandatory in order to estimate the capacity available to the mobile user.

An embodiment is directed to a method to identify cellular channel properties. A computing device, such as a mobile phone receives a cellular signal. The cellular signal includes one or more control messages. The control messages are formed by a plurality of control channel elements and encoded using an associated cyclic redundancy check and a temporary identifier. The method locates each control message by identifying the one or more of the plurality of control channel elements forming the control message. Next, the method derives a set of candidate calculated cyclic redundancy checks and, uses the derived candidate calculated cyclic redundancy further derives candidate temporary identifiers. A validation is performed on the candidate temporary identifiers to determine the actual temporary identifier from amongst the derived candidate temporary identifiers used to encode the control message. The control message can be decoded using the actual temporary identifier. The decoded control message indicates cellular channel properties including, for example, the bandwidth assigned to each user utilizing the channel during carrier aggregation.

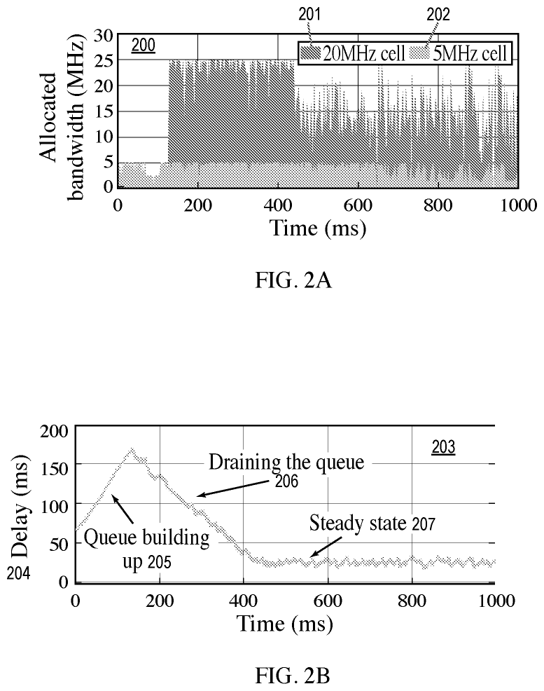

FIG. 2A is a graph 200 of bandwidth allocation using carrier aggregation. A server, e.g., server 101 shown in FIG. 1, is sending a transmission to client 102. The offered load of the server 101 has a sending rate 105 of 25 MHz, that exceeds the capacity rate 104 of the 5 MHz cell normally used by client 102. This results in packet queuing and transmission delays and/or interruptions. To solve this issue, the carrier aggregation is utilized and a second cell, the 20 Mhz cell is utilized to transmit the signals from server 101 to client 102 and make up the difference between the sending rate 105 and the capacity rate 104. Graph 200 shows the allocated bandwidth to the 5 Mhz cell 202 and 20 Mhz 201 cell. Graph 200 illustrates the problem identified above, namely, that during carrier aggregation, there are abrupt and significant changes to the bandwidth allocation of both the 5 Mhz cell 202 and 20 Mhz 201 cell. These changes are not trackable and/or detectable by existing prior art telemetry methods.

FIG. 2B is a graph 203 of the packet delay 204 illustrating the effect of the carrier aggregation shown the graph 200 of FIG. 1. Initially, when the sending rate 105 exceeds the capacity rate 104, a queue of packets 205 begins to build as the rate of incoming packets, sent by server, is more than the rate of outgoing packets, using the capacity rate 104, thus, increasing packet delay times. When carrier allocation starts, the capacity rate 104 increases, due to the addition of bandwidth from a second (or more) cell that increases the aggregated capacity rate 104. This results in the packet queue being drained 206, as delay times steadily decrease. After the queue is drained, the delay times return to the steady state 207 and carrier aggregation can be reduced or terminated until another queue builds. This behavior, occasionally cyclical, creates an ever-changing need for carrier aggregation and for the distribution of bandwidth across multiple cells.

Embodiments include the design and implementation of NG-Scope, a tool that exposes the fine-grained capacity-related information applications and transport protocols require for superior performance. Embodiments simultaneously decode the physical layer control channels of multiple cell towers (“cells”), so as to extract highly granular, per-user link and physical layer transmission status information for all users associated with those cells. By combining this data across users within one cell, and fusing data across cells, embodiments observe and account for the effects of carrier aggregation and, thereby, estimate wireless cellular channel capacity more accurately than previous cellular monitors. By reconciling control messages from the cellular physical layer with the packet arrival time series from the transport layer of the user equipment (UE), example embodiments of the invention accurately monitor the downlink delivery process of every packet the user receives across layers and down to the Physical Layer (PHY), enabling better functionality of congestion control algorithms and video applications, which heretofore lacked insight into the PHY.

An example embodiment of the invention is implemented with multiple Universal Software Radio Peripheral (USRP) software-defined-radios, one host personal computer (PC), and one mobile phone, in a design that synchronizes and fuses information from these sources. USRP is used in an embodiment because the design requires customization to the firmware of the cellular module. However, alternative embodiments of the invention, are directly implementable on mobile devices or other user devices. The performance evaluation in a commercial cellular network validates the accuracy and measurement resolution of the example embodiment of NG-Scope. The example embodiment NG-Scope's control channel decoder achieves a reduction in missed control messages to 0.8% (an 82% reduction compared to OWL). The example embodiment NG-Scope reduces the rate of false positives (detection of nonexistent control messages) by 92% compared to OWL. Further results show that even though wireless capacity varies significantly with mobility, competing traffic within each cell and the number of aggregated cells, the example embodiment NG-Scope is still capable of tracking the resulting capacity variations.

Embodiments enable new experimental observations on cellular wireless physical-layer and link-layer operations. Firstly, it was observed that there exist dedicated cell towers that only function as a secondary cell to deliver carrier-aggregated downlink traffic. Without competition from primary users, such a cell ensures a stable capacity boost for UEs, motivating a congestion control method that can exploit such an opportunity. Secondly, it was observed that with carrier aggregation enabled, the cellular network saturates the primary cell before the potentially higher speed secondary and tertiary cells, resulting in inefficient bandwidth usage. Lastly, cross-cell traffic correlation was observed, the effect of competing for traffic propagating to other cells via carrier aggregation.

To further demonstrate the advantage of embodiments of the invention's complete cell-wide information over the partial information observed by existing methods such as MobileInsight, embodiments of the invention were compared with two systems built atop of MobileInsight: CLAW for capacity tracking and BurstTracker for bottleneck determination. Experimental results show that embodiments of the invention achieve superior performance compared to these two systems.

### LTE Primer

In this section, the relevant parts of LTE's Layer 1 and 2 data-plane designs are discussed, focusing on frequency division duplexing (FDD), the mode cellular operators use most widely.

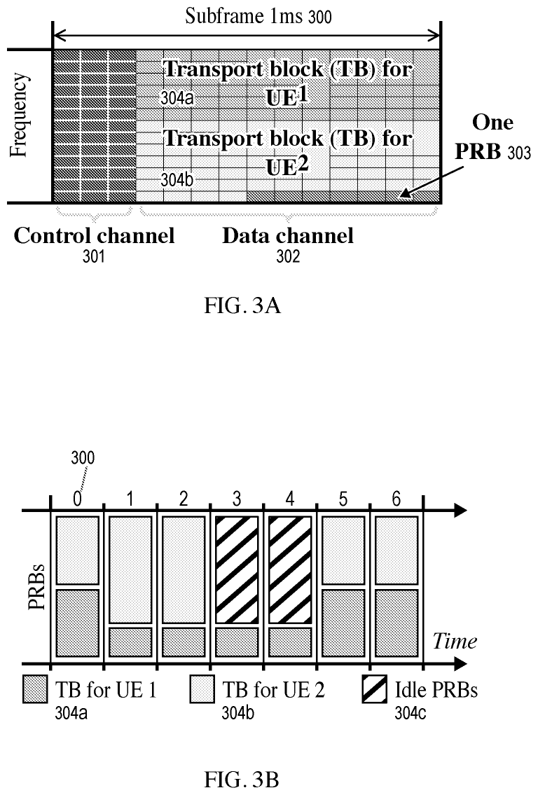

FIG. 3A is a diagram of the structure of a LTE 1 ms subframe 300. A LTE transmission uses OFDMA in the physical layer, dividing the channel into physical resource blocks (PRB) 303, bounded by frequency and time subdivisions of the subframe 300. The PRBs span 12 OFDM subcarriers in frequency and 500μ in time. LTE also divides the time into millisecond-length subframes 300, consisting of 14 OFDM symbols in time. The subframe 300 is divided into a control channel 301 carrying control information and a data channel 302 carrying transport blocks 304a and 304b (304 collectively) (TBs) for specific users. Roughly speaking, within the subframe 300, LTE allocates one to three OFDM symbols to a control channel 301 (containing resource allocation information), and the remainder to a data channel 302.

FIG. 3B is an illustration of resource allocation between transport blocks of a LTE transmission. FIG. 3B shows a sequence of subframes 330 comprised of transport blocks 304a and 304b for a UE1 and UE2, respectively. Depending on traffic load and competition across users, LTE allocates PRBs 303 inside the data channel 302 to one or more UEs. This results in the amount of PRBs allocated to each user's transport block, and therefore allocated bandwidth of the LTE channel, varying over the sequence of subframes 330. If traffic load is reduced below the total bandwidth of the LTE signal, excess PRBs 203 may become idle 304c and contain no transmitted data for any user. While not shown in FIG. 3B, each subframe in the sequence 330 includes a control channel 301 along with the data channel comprised of the transport blocks 304.

Wireless transmissions are subject to errors. LTE relies on a Hybrid ARQ (HARQ) mechanism at the link layer to retransmit errored data bits. LTE's HARQ adopts a stop-and-wait scheme, sending one transport block 304 in each subframe 300 and then waiting for an acknowledgment from the receiver. If the decoding of a transport block fails, the cell tower resends the erroneous transport block, after eight milliseconds of the original transmission. An explicit new-data indicator is included in the control message within the control channel 301 for every transport block 304 to differentiate the original transmission from the retransmission. For example, in FIG. 3A, because there are two transmission blocks 304a and 304b in data channel 302, control channel 301 will contain, within its allocated PRBs 203, two control messages. Each control message associated with a respective transmission block 304a-b. One stop-and-wait HARQ process cannot send any data while awaiting an acknowledgment. For continuous data delivery, LTE starts eight HARQ processes that run in parallel, for every associated mobile device.

### System Design

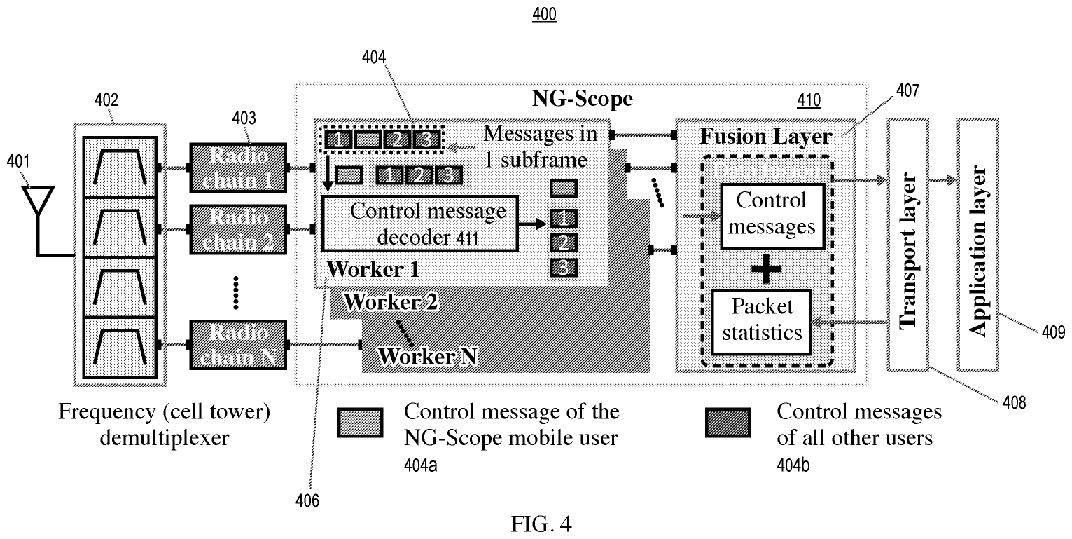

FIG. 4 is a diagram of the system architecture 400 of an example embodiment of the invention. System architecture 400 includes an NG-Scope module 410 that can be implemented using the hardware and software of user devices, such as a mobile phone, or any computing device known in the art. Some embodiments of the invention consist of only NG-Scope module 410. Alternative embodiments of the invention include parts of or all of system architecture 400 shown in FIG. 4. The NG-Scope module 410 is comprised of one or more control channel decoders 411 that locate and decode control messages in subframes of a received signal and a fusion layer 407 that fuses the cross-layer information, control message information from the physical layer and packet statistics from the transport layer, to provide a complete view of wireless cellular communication to higher layers such as the transport layer 408 and application layer 409.

In operation of the system 400, a signal or other wireless communication is received by antenna 401. A mobile user, with carrier aggregation triggered, communicates simultaneously with multiple cell towers. Frequency demultiplexer 402, identifies and separates the radio chains 403 contained in the received signal. Each radio chain 403 originating from a different cell tower. At least due to carrier aggregation, each subframe, e.g., 300, of radio chains 403 may include multiple transport blocks 304, one transport block contains the signal intended for the mobile user and additional transport blocks contain signals intended for other users. If this is the case, each subframe 300 of radio chains 403 also includes multiple control messages 404, one control message 404a associated with the transport block containing the signal intended for the mobile user and additional control messages 404b intended for other users. At least because of the potential use by other users of radio chains 403, it is necessary to decode all control messages 404 to identify the capacity of the cell towers transmitting radio chains 403 and the total capacity available (the aggregate capacity of all cell towers broadcasting the signal received by antenna 401) to the mobile user.

The mobile user, starts one worker 406 to decode the control messages 404 from one of the radio chains 403 originating at one of the cell towers using the control message decoder 411. In some embodiments, other workers 406, in parallel, decode the control messages from the other radio chains 403 originating from other cell towers using additional instances of the control message decoder 411. The control message decoder(s) 411, as detailed further below, are able to decode all user's control messages 404 in the control channels of radio chains 403, even the control messages intended for other users 404b. In the fusion layer 407, the example NG-Scope embodiment 410 fuses information from the decoded control messages 404 from the physical layer with packet statistics, such as packet arrival time, one-way delay, and packet size, from the transport layer 408, which are reported back to the transport layer 408 and application layer 409 to facilitate congestion control or video quality selection, amongst other examples.

### Control Message Decoder

What follows describes control message decoding that may be employed by embodiments. For instance, the following description of decoding functionality may be implemented by the control message decoder 411 utilized by embodiments of the invention, such as NG-Scope 410. The control message decoder 411 is capable of decoding every control message 404 inside a subframe, thus providing a full picture of the bandwidth usage of the cell towers 402 at millisecond time granularity.

### Message Encoding and Decoding

A control message is a bit-string where each bit or group of bits inside the message represents various control information, such as the PRB 303 allocation of the subframe or the MCS index. Length of the control message bit-string and the exact information each bit conveys depends on the message format a base station, e.g., 402, selects for each message. The base station calculates a 16-bit cyclic redundancy check CRC (hereinafter “calculated CRC”) based on the content of the control message, and then exclusive ors (XORs) the calculated CRC with another 16-bit physical layer ID of a mobile user who is the intended receiver of the control message. For non-limiting example, the 16-bit physical layer ID may be a cell radio network temporary identifier (C-RNTI). While embodiments of the invention discussed herein are directed to control messages encoded using the XOR function, embodiments are not limited to using only the XOR function and it should be clear to those skilled in the art that other functions with similar properties can be utilized. The base station 402 appends the XOR-ed value (hereinafter the “appended CRC”) at the end of the control message and encodes the message and the appended CRC using convolutional code.

FIG. 5 is a diagram of the encoding process of a control message 500. The control message 500 is used to derive the calculated CRC 501 based on the content of the control message 500. The calculated CRC 501 is then used as an input to an XOR function along with the user id 502, in this non-limiting example the C-RNTI, of the intended recipient user of the data within a transport block associated with the control message 500. The XOR function produces, as an output, an appended CRC 503. The control message 500 and the appended CRC 503 are then encoded to create to convolutional encoded message 504 that is broadcasted in the control channel, e.g., 301, of a subframe, e.g., 300.

During a decoding process by a recipient device, the appended CRC 503 serves two purposes, message verification and receiver identification. After receiving and performing convolutional decoding of the convolutional encoded message 504, a mobile device separates the 16-bit appended CRC 503 from the control message 500. To verify the correctness of the decoding process, the mobile device calculates the calculated CRC 501 using the decoded control message 500 and, then, XORs the calculated CRC 501 with its own C-RNTI 502. When the XOR-ed value matches with the appended CRC 503, the decoding is successful and it can be confirmed that the mobile device is indeed the intended receiver of the control message 500.

### The Distribution of Control Messages Inside Control Channel

A base station transmits the convolutional encoded message(s) 504 via the physical control channel 301 of a subframe 300, as shown in FIG. 3A. Even though the number of bits that each control channel contains varies with the bandwidth of the base station 402, this number is much larger than the size of one convolutional encoded control message 504. For instance, the control channel of a 20 MHz base station is capable of transmitting a maximum of 84 control messages. Therefore, to organize the transmission of control messages, the base station 402 aligns the bits of the control channel and groups every 72 consecutive bits into a control channel element (CCE).

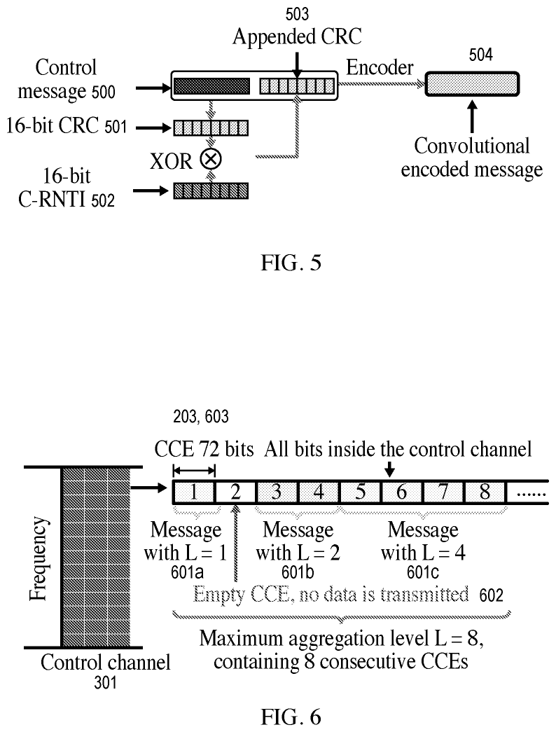

FIG. 6 is an illustration of the distribution of encoded control messages 601a, 601b, and 601c (collectively 601) inside the control channel 201, 601. The bits inside the control channel 201, 601 are aligned in order and then grouped into 72-bit CCEs 603. The control channel elements 603 can correspond to the PRBs 203 of the control channel 201. Control messages 601a, 601b, and 601c are comprised of consecutive control channel elements 603. Each encoded message 601a, 601b, and 601c occupies L consecutive control channel elements 603, where L [1, 2, 3, . . . 8] is referred to as the aggregation level. The size of the convolutional encoded control message 504 is smaller than one CCE 603 so a message is repeated multiple times if it occupies L>1 CCEs 603 which provides extra redundancy over the convolutional code and, thus, extra protection over bit errors. The base station 402 transmits nothing in empty CCEs 602 that contain no control messages 601.

Typically, one mobile user only decodes its own control message. In contrast, embodiments of the invention, such as NG-Scope 410, decode the whole control channel 201, 601 to extract every control message 500 contained inside the control channel 201, 601. This requires the following challenges to be overcome by the control message decoder 411.

### Challenge: Unknowns

One of the key challenges of implementing the decoding utilized by embodiments of the invention is that many important parameters of both the mobile users and the control messages are unknown. Firstly, the physical layer IDs 502 of other mobile users, i.e., the C-RNTI, are unknown. However, the physical layer IDs 502 are required for both message verification and receiver identification. Secondly, the total number of control messages contained, and their distribution, inside the control channel 201, 601 is unknown. Thirdly, for each possible control message, its format and aggregation level (L) are also unknown. Exhaustively searching all possible combinations of location, aggregation level, and format is a possible solution, but results in significant computational overhead. To address the above challenges, embodiments of the invention utilize a tree-based search algorithm and two message validation and user identification methodologies.

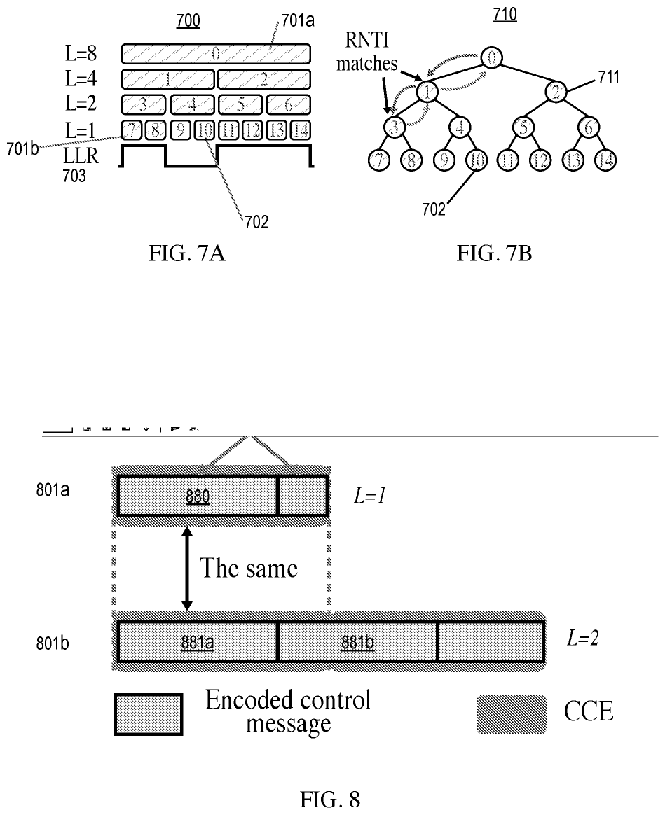

FIG. 7A is a visual depiction 700 of all the candidate locations 701a, 701b (collectively 701) for eight consecutive CCE segments. For example, candidate location 701a has aggregation level L=8, indicating that a control message at that location utilizes 8 consecutive CCEs. Alternatively, candidate location 701b has aggregation level L=1, indicating that a control message at that location utilizes one consecutive CCE. A message with an aggregation level L, has 24 minus L possible locations, within a single, eight consecutive CCE, segment. The whole control channel is divided into multiple such 8-CCE segments. Embodiments of the invention, using e.g., the control message decoder 411, organize the search space of every 8-CCE segment into a binary tree hierarchy, where eight consecutive CCEs are represented by eight leaves and a root represents the message that aggregates the eight leaves.

FIG. 7B is a visual depiction 710 of a binary tree hierarchy utilized by embodiments of the invention for searching eight consecutive CCE segments. The advantage of using a tree-based search is that once any parent node is decoded successfully, embodiments of the invention area able to skip searching all of the parent node's children nodes since one bit cannot be decoded twice. The nodes 711 in the tree 710 represent the candidate locations 701 of a control message.

The tree can further be pruned by identifying empty CCEs 702. Empty CCEs 702 do not contain the control message. The received empty CCE 702 contains no data, only Gaussian noise, which results in significant uncertainty during the demodulation. Therefore, embodiments of the invention inspect the confidence of demodulating the bits inside a CCE, i.e., the log-likelihood ratios (LLRs) 703, shown in FIG. 7A, and identifies a CCE as empty if the average LLR of the demodulated bits is below a threshold. Embodiments of the invention identify empty leaf nodes using LLR 703 and mark a parent node, e.g. node 4, as empty if all of their children are empty, e.g. nodes 9 and 10. The majority of CCEs inside the control channel are typically empty in a commercial LTE network since the base station transmits less than four control messages in more than 99% of subframes. Consequently, embodiments of the invention significantly reduce the computational overhead by identifying, and then, skipping the empty CCEs.

### Challenge: Deriving the C-RNTI

C-RNTI 502, or other equivalent ID, is necessary for message validation and receiver identification. Embodiments of the invention are able to separate the control message 500 and the appended CRC 503 after decoding the received convolutional encoded message 504. The decoded control message 500 can then be used to calculate the calculated CRC 501. Therefore, in a reverse of the encoding process, the C-RNTI 502 can be derived by XOR-ing the calculated CRC 501 and the appended CRC 503. The derived C-RNTI 502 is only correct when the control message 500 is correctly decoded. Therefore, the derived C-RNTI 502 can be used to validate the decoded control message 500. Additionally, embodiments of the invention may derive multiple candidate C-RNTIs 502 based upon proposed decoding of the control message 500 and a correct decoding of the control message 500 can be identified by performing validation processes using the candidate C-RNTIs 502.

### Message Validation Via Child-Ancestor Matching

The following is a non-exclusive technique to verify the decoded control message 500 and the derived C-RNTI 502. This technique relies on the observation that the first half of the message with L is exactly the same as the whole message with L−1.

FIG. 8 is an illustration of a repeated control message 880 within two sets of CCEs with aggregation level 1 (881a) and 2 (881b), respectively. FIG. 8 shows that both CCE sets 881a and 881b start with the same control message 880. According to the observation, it can be known that embodiments of the invention will get exactly the same results when decoding the whole message with L and decoding only its first half. Therefore, when searching and decoding potential control messages in candidate locations based on the tree 710 shown in FIG. 7B, after a search of one node in the tree, embodiments of the invention compare the decoded messages from this node with the messages from the node's decoded ancestors. If these two messages include the same decoded payload message 880 and derived C-RNTI, the decoded message 880 is identified as validated and the associated C-RNTI is the ID of a real mobile user. Accordingly, the children of the identified ancestor are removed from the tree.

### Message Validation Via Temporal UE Tracking

The above described children-ancestor matching technique cannot handle messages with low aggregation levels. Therefore, embodiments of the invention can also utilize a validation scheme by leveraging the temporal user pattern. Leveraging the temporal user pattern relies on the key observation that C-RNTIs that reappear within a short period of time (16 ms in example implementations) are likely real, as C-RNTIs calculated using incorrect control message parameters (location, aggregation, and format) are random and evenly distributed. The possibility of re-hitting the same C-RNTI generated using wrong parameters can be calculated according to the birthday paradox. As the space of possible C-RNTIs 502 is large in size (2¹⁶, if 16 bits in size), the re-hitting possibility is nonetheless extremely small. For example, the possibility that two C-RNTIs reappear within 1,000 messages are 1×10⁻⁴.

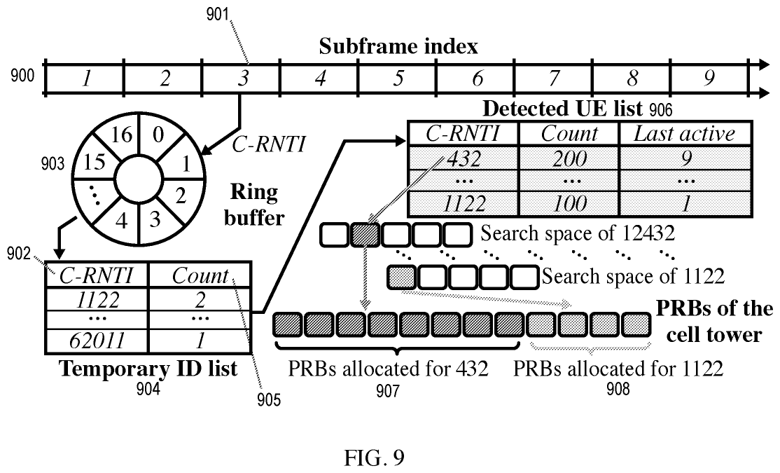

FIG. 9 is a diagram of a UE tracker utilized by embodiments of the invention. In FIG. 9, a signal 900 composed of at least nine subframes 901 is received by a user device utilizing an embodiment of the invention with a UE tracker. The UE Tracker is configured to identify if the derived C-RNTIs 902 from the signal 900 belong to actual user devices (“UE”). The UE Tracker first stores the derived C-RNTIs together with the corresponding control messages. An embodiment decodes the control messages in subframes 901 and derives the C-RNTI's 902 from the control messages. The UE Tracker uses a ring buffer 903 to buffer the control messages from the 16 most recent subframes 901, and maintains a temporary ID list 904 that stores the count 905 of appearances of each C-RNTI 902 in the ring buffer 903. If the C-RNTI 902 count 905 is larger than two, embodiments of the invention identify it as the ID of a real UE and move it to the detected UE list 906. The UE tracker searches the ring buffer 903 for control messages associated with C-RNTIs 902 in the detected UE list 906 and said control messages are identified as valid control messages. The Detected UE list 906 records the last active time of each C-RNTI 902 (the index of the most recent subframe that this C-RNTI is observed). A C-RNTI 902 that is inactive for 10 seconds is removed from the Detected UE list 906.

To reduce the number of buffered messages, embodiments of the invention filter out control messages with a large number of coded bit errors by re-encoding each decoded control message into coded bits, then comparing the result with the original coded bits inside the received CCEs 603 to calculate the ratio of bits that are erroneous. Embodiments of the invention drop received control messages with more than 25% code bits flipped, which is a very high threshold that filters out extremely noisy messages and misses almost no true positive messages, while allowing false positives through, which are not identified as the ID of real UEs by the UE Tracker of FIG. 9.

### Message Validation Via Search Space Matching

Different UEs are assigned different locations (allocations of consecutive PRBs), referred to herein as “search spaces”, within a control channel to contain their control messages to prevent overlap and interference. The search spaces for an UE can be derived based on the physical layer ID (e.g., C-RNTI 902) of that UE. For example, the UE specific search space can be identified by hashing the C-RNTI of the UE. This provides another method for validating the decoded control messages. If a control message is decoded and used to calculate a C-RNTI that is located within the search space assigned to the that C-RNTI, the decoded message can be validated. FIG. 9 provides an illustration of the search space for C-RNTI 12432 and C-RNTI 1122. FIG. 9 shows that the PRBs 907 allocated for the UE with C-RNTI 432 and the PRBs 908 for the UE with C-RNTI 1122 add up to the total PRBs 909 of the base station, i.e., cell tower.

This shows that when the PRBs allocated to a certain number of UEs (two in the example of FIG. 9) add up to the total PRBs of the base station, such a group of UEs is highly likely to be real active users.
UE Tracking with Carrier Aggregation

When carrier aggregation is active, each aggregated cell tower transmits its own control messages to a UE through its own respective control channel. A UE has only one physical layer ID (e.g., C-RNTI 902), and so the physical layer ID of a UE with carrier aggregation enabled appears in the control messages transmitted by all aggregated cells. Embodiments of the invention extract the intersected physical layer IDs across the UE lists of all cells which are identified as having carrier aggregation enabled. Embodiments of the invention identify the primary and secondary cells of the UE according to the time the physical layer ID appears in each aggregated cell. To illustrate, the earliest cell that the physical layer ID appears in is identified as the primary cell, the second earliest cell is identified as a secondary cell, and so on and so forth.

The aforementioned validation methods and possible combinations thereof may be performed by the control message decoder 411 of the NG-Scope module 410 in the architecture 400 shown in FIG. 4. In alternative embodiments, the validation methods and possible combinations thereof may be performed by separate software and/or hardware located on or off the user equipment.

### Data Fusion at Fusion Layer

Referring to FIG. 4, the transport layer 408 timestamps each received packet of each signal. The subframe index, e.g., 901, naturally provides a one-millisecond resolution timestamp for the control messages contained inside it and determined by decoder 411 decoding the control messages 404. However, the timestamps of control messages and packet arrivals are unsynchronized relative to each other. Therefore, embodiments, such as NG-Scope 410, synchronize and align these two cross-layers of information before fusing them in fusion layer 407.

To elaborate, in an embodiment control messages from the PHY layer are time stamped by the subframe index, e.g., 901. An embodiment records the receiving timestamp of the transport layer, e.g., 408, packets (TCP or UDP). The control messages indicate how many bits are transmitted to the UE in each subframe. The base station may transmit less than one, or more than one transport layer packet inside one subframe, as illustrated in FIG. 10, discussed hereinbelow. As such, an embodiment determines which packet is transmitted inside which subframe by aligning the series of control messages and packet receiving timestamps.

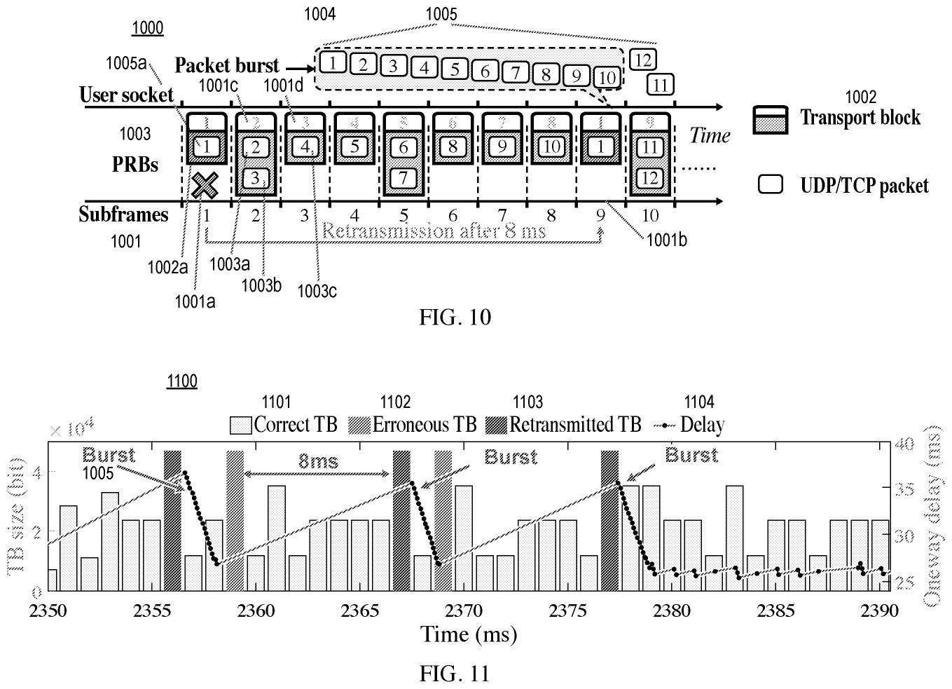

An embodiment aligns the transport layer packet receiving timestamp and the series of control messages using the pattern of retransmissions. The retransmissions of one transport block cause (1) an eight-millisecond delay increase and (2) a burst of packets reported to the transport layer (as shown in FIGS. 10 and 11 discussed hereinbelow). Embodiments identify the retransmissions from transport layer packet one-way delay and receiving timestamp (as shown in FIG. 11). Further, such an embodiment identifies the retransmissions from decoded control messages of that UE. The transport layer packet receiving timestamps are shifted (one shift applies to all timestamps) so that the timestamp of the retransmissions identified from control messages (subframe index) and the timestamp of the retransmissions identified from the transport layer packet receiving timestamps align with each other.

FIG. 10 is an illustration of an example of transport block failure and retransmission. A signal 1000 is comprised of data sent in twelve packets 1005. The packets 1005 are transmitted within transport blocks 1002 assigned to the user device intended to receive the signal 1000. The transport blocks 1002 are composed of PRBs 1003 where there is a varying number of PRBs in different subframes 1001 of signal 1000. For example, two PRBs 1003a, 1003b in the second subframe 1001c and one PRB 1003c in the third subframe 1001d. The PRBs 1003 contain packets 1005. In FIG. 10, the UE fails to decode the transport block 1002a transmitting packet 1005a in the first subframe 1001a. Eight milliseconds after the original transmission, the cell tower retransmits the lost transport block 1002a and its packet 1005a, in subframe 1001b 9. However, the base station continues transmitting data to the UE between the original transmission and the retransmission (subframes 2-8). Assuming the transport blocks 1002 sent over subframes 1001 two to eight are decoded correctly, the UE receives the second to tenth packets 1005 before the reception of the first packet 1005a, causing many out-of-order packet receptions. To prevent out-of-order packet reception from happening at a higher layer, a link-layer ensures in-order transport block 1002 delivery by buffering all out-of-order transport blocks 1002 in a reorder buffer until the retransmission recovers the missing transport blocks. The link-layer then extracts packets 1005 from the transport blocks 1002 and delivers them to the receiving socket, resulting in a burst of packets 1004 received at that layer.

FIG. 11 is a graph 1100 of inter-packet-arrival time resulting from packet decoding failure and the resulting packet burst. Graph 1100 displays the receival time on the x-axis, transport block (TB) size on the left y-axis, and delay on the right y-axis for a sequence of transport blocks. The transport blocks are categorized as correctly decoded 1101, erroneously decoded 1102, and retransmitted 1103. Also displayed on graph 1100 is a line 1104 showing the delay between transport block receival and delivery. Graph 1100 illustrates the slow increase of delay 1104 until a retransmitted transport block 1103 is received that results in a packet burst 1105 being sent. The packet burst 1105 results in a steep decline of the delay 1104 time until an erroneous transport block 1102 is received and the transport blocks are buffered until a retransmitted transport block 1103 is received and a packet burst 1105 can be sent. FIG. 11 shows that the packet burst 1105 reshapes the inter-packet-arrival time. The packets inside the burst 1105 in fact arrive at the UE uniformly, but are instead reported together, creating a large delay 1104 between the packet burst 1105 and the packets received before the packet burst 1105.

From the decoded control message, embodiments identify the starting and ending subframe for each retransmission 1103. From a packet log, the transport layer detects retransmission 1103 based on the eight-millisecond interval between consecutive packets and the packet burst 1105. Embodiments of the invention, therefore, shift the timestamp of the packet log to match the locations of the retransmissions inside the packet log and the control messages. By doing so, embodiments synchronize the packet log with control messages to millisecond precision, the highest resolution possible since the subframe index is at the same scale.

### Example Experimental Implementation

Embodiments of the invention can be deployed as a software solution, involving no hardware modifications. In this way, embodiments can be implemented on a commercial mobile phone by customizing the cellular firmware. The source code of the cellular firmware, however, is generally proprietary to cellular equipment manufacturers, and is not accessible for the example implementation described herein. Therefore, what follows is a non-liming example implemented as an open-source prototype. To emulate multiple radio chains of commercial phones, multiple off-the-shelf software-defined radios, (USRPs) were used as a front-end to collect cellular signals. The signals the USRP collects were then sent to a connected PC configured to implement the functionality described herein for control message decoding. A mobile phone is tethered to the PC for cellular data transmission and reception. Packet statistics and the decoded control messages are fused by the middle layer at the PC.

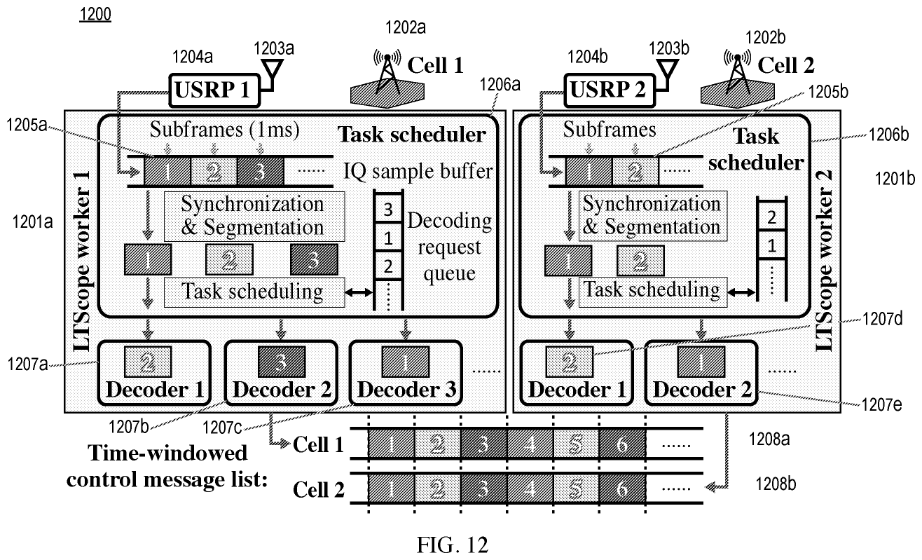

FIG. 12 is a diagram of an example experimental implementation of an embodiment 1200 of the invention. FIG. 12 shows two instances of example workers 1201a, 1201b configured to decode a signal propagated by cell towers 1202a and 1202b, respectively. Embodiment 1200 uses a parallel decoding framework where worker 1201a decodes the signal USRP 1204a captures with antenna 1203a and worker 1201b simultaneously decodes the signal USRP 1204b captures with antenna 1203b.

Each worker 1201a, 1201b has a task scheduler 1206a, 1206b thread that synchronizes with the cell tower 1202a, 1202b and separates the received signals 1205a, 1205b into subframes. Each worker 1201a, 1201b also creates multiple control message decoders 1207a, 1207b, 1207c, 1207d, 1207e (collectively 1207), each of which takes one subframe of the signal 1205a, 1205b as input and decodes all control messages inside the subframe. While FIG. 11 shows two workers 1201a, 1201b and five decoders 1207a-e, embodiments are not limited to such a configuration and, instead, embodiments can utilize any number of workers and decoders as desired by a user and/or permitted by hardware and software used to implement the embodiment. The decoders 1207 and/or workers 1201a, 1201b can function in parallel to improve computation times. Example embodiment 1200 starts more than one decoder 1207 threads to guarantee that no matter when a subframe has been separated by the task scheduler 1206a, 1206b, there is a decoder 1207 ready to decode it. In this way, the workers 1201a-b buffer a minimum number of subframes and avoid overflowing the limited socket buffer shared by multiple USRPs 1204a, 1204b. When one decoder thread 1207 finishes its decoding task and becomes idle, it sends a decoding request to the task scheduler 1206a, 1206b. The task scheduler 1206a, 1206b allocates decoding tasks according to the order of the decoding requests it receives. The decoded control messages from one worker 1201a, 1201b are ordered according to the index of its subframe 1205a and 1205b and stored in a list 1208a, 1208b, respectively. The lists 1208a, 1208b store the control messages decoded from the most recent 320 subframes. Alternative embodiments can store control messages from any desired number of recent subframes.

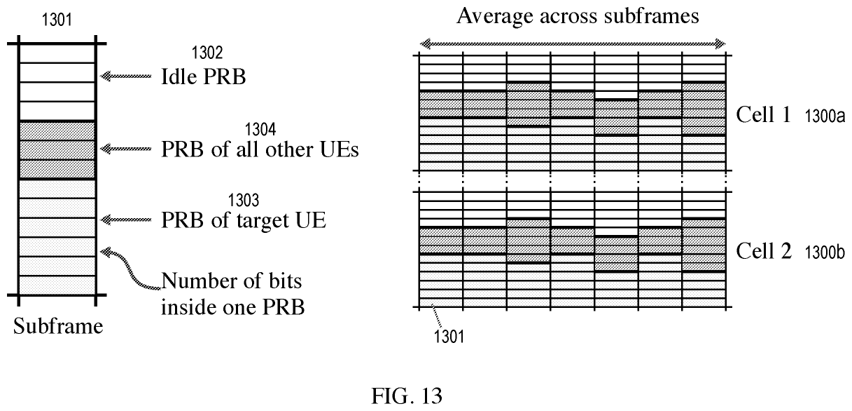

FIG. 13 is an illustration of capacity calculation utilizing the example experimental implementation of an embodiment 1200 described hereinabove in relation to FIG. 12. FIG. 13 includes an illustration of a subframe 1301 of a signal. The PRBs of the subframe 1301 are allocated between idle PRBs 1302, PRBs of the target UE 1303, and PRBs of other UEs 1304. The example experimental implementation 1200 estimates and updates the capacity at the frequency of every one millisecond. After decoding all the control messages of one subframe, the example experimental implementation 1200 knows the PRBs the base station allocates for the target UE 1303 and the total PRBs allocated for all other UEs 1304, as shown in the illustration of subframe 1301. The example experimental implementation 1200 calculates the total available PRBs for the target UE as the allocated PRBs 1303 for the UE plus the idle PRBs 1302 that are not allocated. The base station also tells the UE the number of bits that each PRB can carry, via the decoded control message. Therefore, the example experimental implementation 1200 calculates the capacity of the target UE as the available PRBs multiplied by the number of bits inside each PRB. To smooth the estimation, the example experimental implementation 1200 averages the available PRBs (idle PRBs 1302+UE assigned PRBs 1303) and the number of bits each PRB carries across multiple decoded subframes 1301, as shown in the outputs 1300a, 1300b for each cell 1201a, 1201b. If carrier aggregation is enabled, the example experimental implementation 1200 obtains the overall capacity of the UE by summarizing the capacities, determined by outputs 1300a, 1300b, of all aggregated cells 1201a, 1201b.

### Evaluation

What follows is a description of performance evaluation quantifying embodiments of the invention's accuracy and responsiveness in measuring cell load in a head-to-head comparison with OWL. Next, embodiments of the invention's ability to provide extremely high-granular and accurate cell load estimation in the presence of bit rate adaptation and carrier aggregation is demonstrated, for both stationary and mobile user scenarios. Then, a look at carrier aggregation in-depth, demonstrating unique insights into operations that embodiments of the invention enable for the first time. Last, embodiments of the invention are compared with CLAW and BurstTracker, two systems built atop of MobileInsight, to demonstrate the advantage of complete cell-wide information decoded by embodiments from control channels.

### Experimental Configuration

Experiments were run with six AT&T cell towers that provide LTE service for the testing area, a university area near a busy street. The detailed configurations of all six cell towers are listed in Table 1 below. The index of each cell is used to refer to that cell in later sections.

TABLE 1
Evaluation cell tower configurations: frequency
bandwidth, center frequency, and antenna count.
#Configuration

(1) 20 MHz, 1.94 GHz, 2 ant.
(2) 10 MHz, 739 MHz, 2 ant.
(3) 10 MHz, 723 MHz, 2 ant.
(4) 10 MHz, 2.36 GHz, 4 ant.
(5) 5 MHz, 872 MHz, 4 ant.
(6) 5 MHz, 1.95 GHz, 4 ant.

### Decoding Accuracy

In this section, embodiments of the invention's decoding accuracy are investigated and compared head-to-head with OWL, which has demonstrated superior performance over LTEye. Without hacking the cell tower, it is impossible to get the exact ground truth of control messages the cell tower sends in the control channel of each subframe. To infer the ground truth, four USRPs were set up to listen to the same cell tower at four locations that are one meter apart from each other and utilize an embodiment of the invention to decode the received signals. Since the signals received by these four USRPs are uncorrelated, the decoding results using signals from different USRPs are independent of each other. Therefore, control messages that appear in the decoding results of all four USRPs are highly likely to be correct and thus are treated as the ground truth of control messages that the cell tower sends. At each location, the decoding was repeated using OWL. The entire experiment was repeated for 20 combinations of USRP locations.

FIG. 14 is a comparison between the percentage of control messages that are correctly decoded by an embodiment of the invention and OWL. The calculated percentages of control messages correctly decoded by an embodiment of the invention are plotted in graph 1400 and the calculated percentages of control messages correctly decoded by OWL are plotted in graph 1401. The embodiment of the invention's decoding performance is much more stable and accurate than OWL across locations. On average, 90.4% of messages decoded by the embodiment of the invention are correct, while the percentage is 65.3% for OWL.

The true negative messages that are missed on any USRP, and false positive messages that are decoded with error and not filtered out, are two main sources of incorrectly decoded messages. Since the exact ground truth of every message the base station sends was unknown, the exact number of true negatives and false positives is similarly unknown. Therefore, the following two experiments were conducted to determine the number of true negatives and false positives for an embodiment of the invention and OWL. 300 Mbits of data was sent from a server to a Galaxy S8 user device. The amount of data received from the socket of the user device was recorded. Further, the amount of data delivered from cell towers to the user device from the control messages decoded using an embodiment of the invention (e.g., “NG-Scope”) and OWL was counted. The experiment was repeated at eight locations with varying reference signal received power (RSRP).

FIG. 15A is a graph 1500a of the percentage of data that is missing from control messages decoded by an embodiment of the invention 1501a and OWL 1502a. The results plotted on graph 1500a are calculated by comparing (i) the size of data derived from the control channel through decoded control messages with (ii) the data received from the socket. This comparison yields the percentage of data that is missing from the control channel. It can be seen that the embodiment of the invention 1501a captures almost all the User Datagram Protocol (UDP) traffic sent from the server, with an average missing percentage of 0.83%. This is an 83% reduction compared to OWL's 1502a average missing percentage of 4.5%. Missing control messages results in missing data. As such, the embodiment of the invention 1501a has a smaller percentage of true negatives in its decoding results.

FIG. 15B is a graph 1500b of the percentage of false positives detected by an embodiment of the invention 1501b and OWL 1502b. Generated false positives, i.e., a false control message and, thus, a nonexistent resource allocation can also be quantified. The total allocated PRBs of one subframe (calculated by summing up the allocated PRBs of every control message) may exceed the maximum number of PRBs the cell supports, due to false positives. The percentage of such “excess” subframes are calculated to infer the generated false positives and the results are plotted on graph 1500b. The graph 1500b shows that OWL 1502b generates a large number of false positives (8%-12%), so that it may overestimate the overall usage of the whole cell. The embodiment of the invention 1501b reduces the false positives to the greatest extent possible via its message validation schemes.

### Computational Cost

In this section, the computational cost of embodiments is investigated. The basic operation that embodiments perform is the convolutional decoding of one control message. Therefore, the computation of each convolutional decoding and the total number of decoding embodiments conduct in each subframe determines the computational costs of embodiments. Embodiments of the invention use the software-implemented Viterbi decoder configured to implement the functionality described herein.

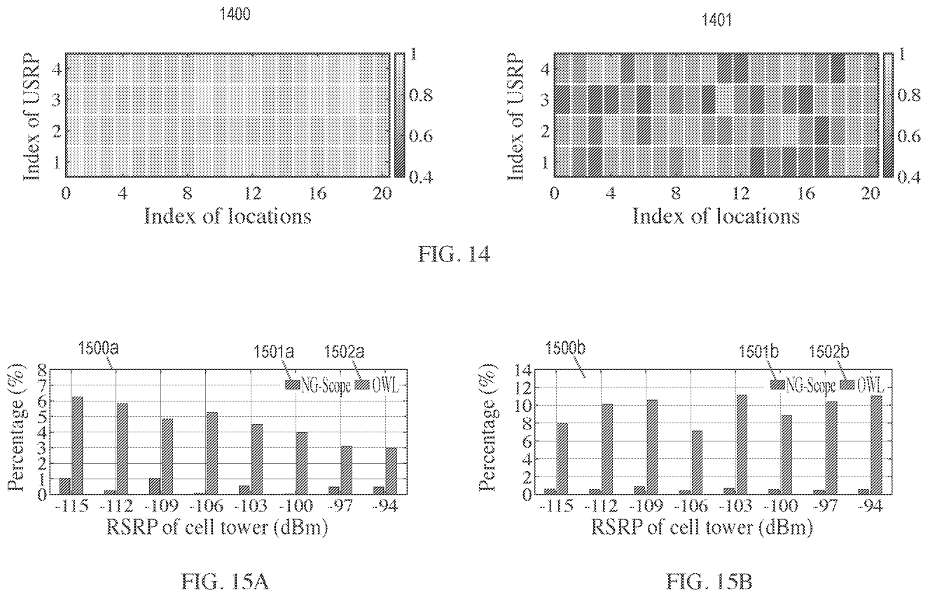

FIG. 16A is a graph 1600a of the distribution of time such a Viterbi decoder takes to decode 3.8 million control messages transmitted by a 20 MHz base station. The Viterbi decoder used an Intel i7-8700 CPU, from which it is shown that the time is smaller than 4.51 us for 99% of cases.

FIG. 16B is a graph 1600b of the number of convolutional decoding attempts performed by an embodiment of the invention inside each subframe, when decoding the control channel of a 5, 10, and 20 MHz base station. The graph 1600b illustrates that embodiments of the invention perform less than 80 convolutional decoding attempts inside 99% of subframes of all three base stations (5, 10, and 20 MHz). It is noted that though a mobile phone only needs to decode its own control message, the phone still needs to blindly perform multiple rounds of convolutional decoding attempts as the mobile phone does not know all the parameters that are required to decode its control message. The mobile phone even does not know whether the base station transmits a control message for it or not, before the blind decoding. According to the LTE standard, the maximum decoding attempts each mobile phone needs to perform is 44. Therefore, embodiments of the invention introduce reasonable extra computational cost, i.e., around 1× more convolutional decoding attempts compared with a legacy mobile phone.

### The Number of Active Users Inside Each Subframe

Embodiments only introduce a small amount of extra computational overhead because the number of active users inside each subframe is limited. An active user is defined to mean that the base station allocates bandwidth for the user in one subframe and, thus, transmits one corresponding control message to that user. The number of active users in each subframe can be derived by counting the number of decoded control messages.

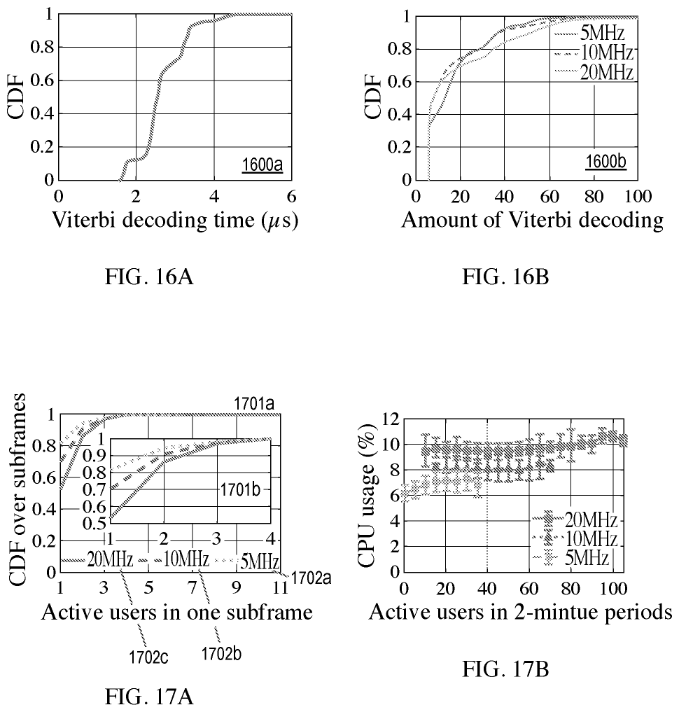

FIG. 17A is a set of graphs 1701a, 1701b of the cumulative distribution function (CDF) of the number of active users in a subframe of a base station signal in 72 hours. Graph 1701b is an excerpt of graph 1701a showing additional detail. As the CDF approaches 1 at 4 active users, it can be clearly seen that there are less than four active users and, thus, less than four control messages in 99.9% of the subframes for all three base stations 1702a, 1702b, and 1702c. Due to the limited amount of control messages to be transmitted, there exists a large number of empty CCEs inside the control channel and, thus, most of the nodes of the tree used in embodiments, e.g., tree 710 in FIG. 7B, are empty. This significantly reduces the search space.

### The Mobile Users the Base Station Serves

Even though the base station transmits data to a limited number of mobile devices inside each subframe, the base station serves tens or even hundreds of mobile devices on a longer time scale. To demonstrate the number of mobile devices served by the base station during the 72 hour period monitored in FIG. 17A, the time period is divided into 4,320 two-minute periods. FIG. 17B is a graph 1700 of CPU usage vs. number of users that the base station serves in the 4,320 two-minute periods. Graph 1700 shows that a 20 MHz base stations talks to 100 different mobile devices within 2 minutes. Graph 1700 also plots the CPU usage of embodiments of the invention during each interval. It is shown that the embodiments of the invention's computational costs do not increase proportionally with the number of active users the base station serves.

### Highly-Granular Capacity Tracking Using NG-Scope

Hereinbelow, an evaluation of an example embodiment of the invention's (“NG-Scope”) highly-granular capacity tracking is provided. The evaluation first considers a single cell followed by the aggregated capacity with CA triggered.

### Single Cell Capacity

NG-Scope tracks the LTE wireless link capacity based on the available PRBs and the bits each PRB carries for a certain user. The bits each PRB carriers for one user are determined based on a Modulation and Coding Scheme (“MCS”) index and the number of spatial streams inside the control message.

FIG. 18 is a set of graphs that plot the tracked MCS index 1800a, 1800b, the available PRBs 1801a, 1801b, and the calculated LTE link capacity 1802a, 1802b for a static UE 1800a, 1801a, 1802a and a mobile UE 1800b, 1801b, 1802b. The static UE was at a location with the average power received from a single reference signal (RSRP) equaling 98 dBm. For the static UE, the tracked MCS index (1800a) is stable, while the available PRBs (1801a) of the cell changes dramatically and the capacity (1802a) varies accordingly. For the mobile UE, both the MCS index (1800b) and available PRBs (1801b) fluctuate, but at different time scales.

### Aggregated Capacity

The aggregated capacity for a certain UE with carrier aggregation (CA) was also investigated. Two mobile phones were tested, a Samsung Galaxy S8 and a Xiaomi MIX3. The MIX3 is aggregated with two cells.

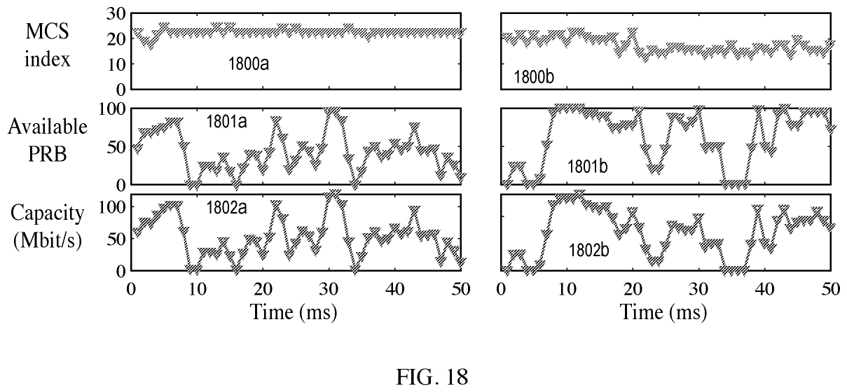

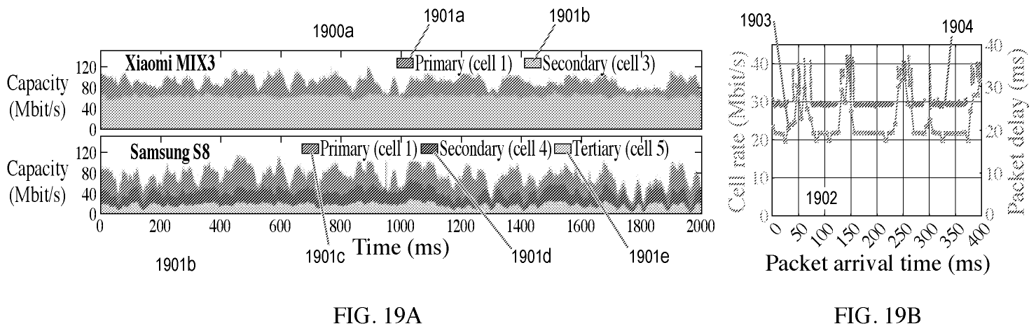

FIG. 19A includes plots 1900a, 1900b, of the aggregated capacity of the Samsung Galaxy S8 and the Xiaomi MIX3 mobile devices respectively, determined using an example embodiment of the invention. The capacity of each cell 1901a-e (collectively 1901) used to transmit data to the phones is represented on plots 1900a, 1900b with different colors. For the Xiaomi MIX3, the capacity provided by the secondary cell 1901b is large and stable, while the capacity provided by the primary cell 1901a varies significantly. The reason is that the secondary cell 1901b operates on LTE band 29, which has only a downlink frequency (generally, one Frequency Division Duplex (FDD) band is divided into uplink and downlink frequency blocks), and no UE associates with LTE band 29. This secondary cell 1901b is installed purely for carrier aggregation, i.e., to work as a secondary cell for downloading data to the UE, so it is idle most of the time. The S8 is aggregated with three cells 1901c, 1900c, and 1900d. Cell 1901c also functions as cell 1901a. The aggregated capacity for the S8 is shown by plot 1900b, which shows that the capacities provided by three cells 1901c, 1901d, and 1901e have large variation and the aggregated capacity varies accordingly.

### Impact of TB Errors and its Retransmissions

It is noted that not all physical layer capacity is used for transmitting data. When transmission block (TB) errors happen, the cell tower needs to allocate bandwidth for both retransmission of the erroneous TB (as illustrated in FIGS., 10 and 11) and ongoing data transmission. This results in an increase of the instantaneous data rate at the LTE physical layer. To demonstrate this, the LTE physical layer data calculated from the control message and the one-way delay recorded at UE were tracked and plotted, with a server offered load of 20 Mbit/s.

FIG. 19B is a graph 1902 of the tracked LTE physical layer data calculated from the control message decoded using an example embodiment and the one-way delay recorded at UE. In graph 1902, the packet arrival time is on the x-axis, the cell rate transmission 1903 is displayed on the left y-axis and the packet delay 1904 is displayed on the right y-axis. FIG. 19B shows the ability of embodiments of the invention to fuse two separate sources of data, cell rate transmission 1903, from the decoded control messages and packet delay 1904, from the transport layer. The packet bursts and eight-millisecond intervals in one-way delay identify where the retransmission happens, as discussed previously. Even without retransmissions, the LTE physical layer rate (cell rate 1903) is higher than the offered load (20 Mbit/s) due to protocol overhead (LTE protocol headers). When retransmissions happen, the instantaneous physical layer rate increases significantly. The maximum rate can be larger than 40 Mbit/s in this example, which is double the offered load. Since the total physical layer rate capacity of each cell is bounded by the bandwidth, the increasing allocation of capacity for retransmission affects the available capacity for original data transmission, resulting in dynamics of the final available capacity at the transport layer.

### Congestion Control Using NG-Scope

The following is an example implementation that illustrates a benefit of an embodiment of the invention, “NG-Scope.” Embodiments of the invention implement a congestion control algorithm that fully leverages the highly-granular capacity reported by NG-Scope. This achieves high throughput and at the same time, low latency. By default, the congestion control algorithm sets its sending rate to the capacity measured and reported by NG-Scope. Such a rate causes no congestion when the bottleneck of the transmission control protocol (“TCP”) connection is at the cellular link. A congestion is detected when the bottleneck shifts from the cellular link to the Internet and, accordingly, the algorithm falls back to a CUBIC algorithm to match its sending rate to the capacity of the Internet link. The algorithm identifies the bottleneck has shifted back to the cellular link if the rate selected by CUBIC is the same or larger than the capacity reported by NG-Scope.

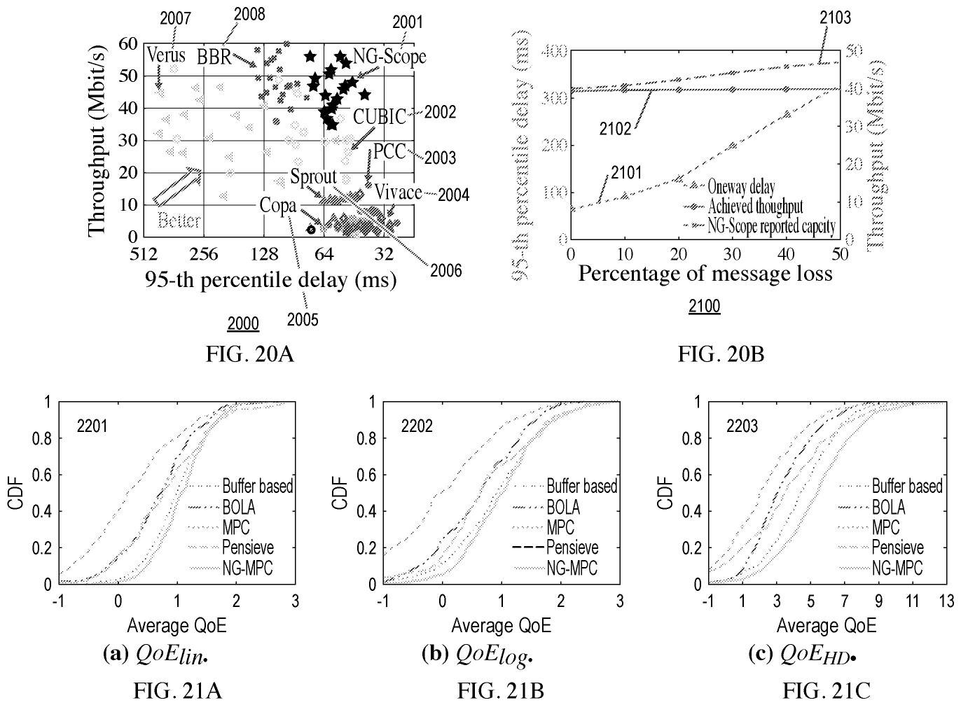

FIG. 20A is a graph 2000 of the average achieved throughput and the 95th percentile one-way delay of eight congestion control algorithms, including a congestion control algorithm 2001 that utilizes an example embodiment. Graph 2000 shows a comparison between the congestion control algorithm utilizing the NG-Scope example embodiment 2001 and seven other congestion control algorithms, including Verus 2007, BBR 2008, CUBIC 2002, COPA 2005, Sprout 2006, PCC 2003, and PCC-Vivace 2004. Each algorithm was tested for 30 seconds and the test was repeated 20 times for each algorithm. All the performance tests were conducted on workdays when the base station is busy. The performance of the algorithms was measured using Pantheon. The performance results in graph 2000 show that with the accurate per-millisecond capacity updates, the NG-Scope based algorithm 2001 is able to fully utilize the capacity provided by the cellular network, maximizing its throughput, and at the same time avoid congesting the network and minimizing its latency.

### Impact Of Missing Control Messages

The impact of missing control messages on the end-to-end performance of the NG-Scope based congestion control algorithm was investigated. In this evaluation, trace-driven emulation was performed using a link emulator: Mahimahi. The control messages that a base station transmits in a 30 second period, were decoded and recorded. Based on this, the available capacity for one mobile user was calculated and fed to Mahimahi. A TCP connection was built over the link emulated by Mahimahi and the recorded control messages were fed to the TCP sender for capacity calculation and congestion control. To emulate the missing messages, 0% to 50% of the decoded control messages were randomly dropped before feeding to the TCP sender.

FIG. 20B is a graph 2100 showing the effect of percentage of message loss on the average achieved throughput and 95th percentile one-way delay achieved with a congestion control algorithm that uses an example embodiment of the invention. Line 2103 is the reported capacity from the congestion control algorithm utilizing NG-Scope. Line 2101 is the measured one-way delay and line 2102 is the actual throughput. As the percentage of missing messages increases from 0% to 50%, the achieved throughput 2102 increases slightly, i.e., from 39.2 to 39.8 Mbit/s, while the delay 2101 increases significantly, i.e., from 64 to 327 ms. With more missing control messages, the sender observes more idle bandwidth from the base station and, thus, the available capacity 2103 is over-estimated, causing frequent congestions inside the network.

### Video Streaming Using NG-Scope

The value of the telemetry data provided by NG-Scope, and other embodiments of the invention, can be demonstrated through the implementation of a NG-Scope based video streaming system. MPC is a state-of-the-art video bitrate adaptation system, which estimates the capacity as the harmonic mean of the video downloading speed in the near past. MPC is described in the following reference which is incorporated herein: X. Yin, A. Jindal, V. Sekar, and B. Sinopoli. A control-theoretic approach for dynamic adaptive video streaming over HTTP. In ACM SIGCOMM, 2015. Embodiments of the invention, for example NG-Scope, can be integrated with MPC by replacing the capacity with the telemetry data measured by NG-Scope. Such an integrated method is referred to herein as “NG-MPC.” The dash.js is used to implement the congestion control algorithm utilizing NG-Scope. This algorithm, NG-MPC, is then compared with MPC, Buffer based ABR, BOLA, and deep learning based adaptive bitrate (ABR) method, Pensieve.

The video quality of experience (QoE) provided by all five adaptive ABR algorithms (NG-MPC, MPC, ABR, BOLA, Pensieve) is evaluated. There exists a wide range of QoE metrics that characterizes the user-perceived video quality, but three important factors are included in most of the QoE metrics: (i) the average video quality, (ii) the quality variations, and (ii) the rebuffering. The following equation is used to summarize their impact on the QoE:

$$QoE = {\sum }_{n = 1}^{N} q ( {R}_{n} ) - μ {\sum }_{n = 1}^{N} {T}_{n} - {\sum }_{n = 1}^{N} {T}_{n} \vert q ( {R}_{n + 1} ) - q ( {R}_{n} ) \vert$$

where N represents the total number of chunks inside a video, Rₙ describes the bitrate of the n-th chunk, q(Rₙ) translates the bitrate to the user-perceived video quality, Tₙ is the rebuffering time when downloading n chunks at bit rate Rₙ, and the final term, Tₙ|q(Rₙ₊₁)−q(Rₙ)|, characterizes the video bitrate changes which penalizes the overall QoE.

Three types of QoE metrics, which are known to those of skill in the art, were considered. The first QoE metric QoEₗᵢₙ was considered in earlier works for both MPC and Pensieve, where the quality mapping function is linear q(Rₙ)=Rₙ. The second metric QoE_{log} was used in evaluating BOLA where the quality mapping function q(Rₙ)=log (R/Rₘᵢₙ) captures the phenomenon that the improvement of user-perceived quality decreases at higher video bitrates. The third metric QoE_{HD} was used to evaluate Pensieve which favors high definition video by assigning a low score to a low-quality video and a much higher score to a high-quality video. To evaluate these metrics for NG-MPC, a DASH server was set up that used Google Chrome as the client video player. Ten videos were streamed using the aforementioned ABR algorithms. Mahimahi was used to emulate the network conditions from cellular traces.

FIG. 21A is a graph 2201 comparing NG-MPC with existing ABR algorithms on QoEₗᵢₙ. FIG. 21B is a graph 2202 comparing NG-MPC with existing ABR algorithms on QoE_{log}. FIG. 21C is a graph 2203 comparing NG-MPC with existing ABR algorithms on QoE_{HD}. FIGS. 21A-C show QoE improvements achieved by NG-MPC over the original MPC. Since the trained model from Pensieve was directly used without retraining it for the utilized cellular traces, Pensieve cannot provide high quality video streaming as its model does not generalize well, which has also been reported by prior works. With the accurate capacity provided by NG-Scope, NG-MPC improves the QoE by 7.6%, 10.1% and 11.4% over MPC for QoEₗᵢₙ, QoE_{log}, and QoE_{HD}, respectively.

### Tracking Frame Loss And Size Using NG-Scope

Embodiments of the invention, for example, NG-Scope, are able to identify retransmitted transport blocks using the new-data indicator of decoded control messages. In the following section, frequency with which retransmissions happen in commercial cellular networks and their impact on cellular packet transmissions are investigated and the benefits of this functionality are illustrated.

### Experimental Methodology

An experiment was run using six AT&T cell towers that provide LTE service for a testing area, a university area near a busy street. The detailed configurations of all six cell towers are listed in Table 1 above. In the static experiment, the mobile phone is placed at one location and the remote server sends UDP packets with a payload length of 1,400 bytes for 10 seconds. The speed of the remote server is varied from 10 Mbit/s to 55 Mbit/s. The phone is connected with the same cell tower (20 MHz bandwidth at 1.94 GHZ) during both the static and mobile experiments.

### Static User

The phone (i.e., UE) is moved to 10 different locations with varying signal strength in a building. From the decoded control message, the number of original (not retransmitted) transport blocks that the cell tower sends to the UE is counted. Among those original transport blocks, the number of transport blocks that have been decoded with bit errors and, thus, require retransmissions, according to the new data indicator (ndi), are counted. The TB error rate, i.e., the ratio of erroneous transport blocks (requiring retransmissions), to the total number of original transport blocks sent is calculated.

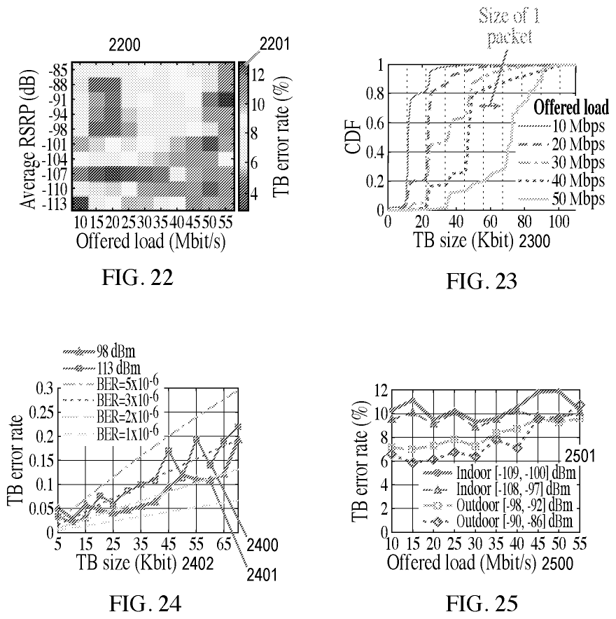

FIG. 22 is a graph 2200 of the transport block error rate as a function of offered load and locations of the user. In FIG. 22, each row of data comes from a different location and is indexed by the average RSRP at that location. Colors, shown in key 2201 represent the value of TB error rate. Graph 2200 shows that the TB error rate varies from 2% to 12%, but there is no obvious pattern of transport block errors across locations. The likelihood of the transport block error at a certain location is determined by the channel at that specific location and how the rate adaptation algorithm works on that channel. It can be observed however, that at each location, the transport block error rate significantly increases with the offered load.

### Relationship With TB Size

It can be hypothesized that increased TB error rate is due to the increased size of the TBs themselves. FIG. 23 is a graph 2300 of the cumulative distribution function for the size of transport blocks sent to a user with varying offered load. Graph 2300 plots the distribution of the size of the TBs sent from the cell tower to the UE. It can be seen that with a higher data rate, TB size increases accordingly, at a multiple of the packet size, i.e., 1,400 bytes. For example, at an offered load of 10 Mbit/s, only one packet arrives at the receiver in each millisecond interval. Accordingly, the cell tower embeds only one packet inside the TB of each subframe, so more than 75% of the TB have a size of only around 1,400 bytes. With increased offered load, more packets are grouped into one TB, increasing its size.

To further validate the hypothesis, all received TBs are grouped into 14 bins, i.e., zero to 70,000 bits with a step size of 5,000 bits, according to their size. The TB error rate for blocks in each bin is calculated. FIG. 24 is a graph 2402 of the transport block error rate as a function of transport block size for locations with RSRP 98 dBm 2401 and 113 dBm 2400. It is shown that the TB error rate increases with TB size. The error rates can then be compared with theory: supposing the error rate of each data bit inside one TB is p and that bit errors are independent and identically distributed (i.i.d.), then the TB error rate can be calculated as 1−(1−p)^{N}, where N is the TB size. The calculated TBR error rates for bit error rate (BER) p of 5×10⁻⁶, 3×10⁻⁶, 2×10⁻⁶, and 1×10⁻⁶, are also plotted on graph 2400. Firstly, it is shown that the experimental data fit the theoretical predictions, including the i.i.d. bit error probability assumption. Secondly, it is also shown that the cellular network maintains the BER for data bits inside the TB at around 10⁻⁶ and that such a BER is slightly different across locations.

### Mobile User

In the mobile experiment, the UE is moved along two indoor and two outdoor trajectories at a speed of two (2) m/s. Each trajectory is repeated 10 times, with varying offered loads from the server, and the RSRP range observed when moving along each trajectory is recorded. The TB error rate is calculated for each offered load.

FIG. 25 is a graph 2500 of the transport block error rate as a function of offered load for a mobile user for indoor and outdoor user trajectories at varying RSRP ranges. The location and RSPR ranges of the plotted data is identified by key 2501. It is shown that the TB error rate of outdoor trajectory exhibits the same pattern as the static experiments: the higher the offered load, the higher the error rate. However, for indoor trajectories, the TB rate is similar for all offered loads. Compared with outdoor trajectories, the channel along the indoor trajectories changes dramatically, due to indoor small-scale fading, resulting in more TB errors when LTE rate adaptation algorithms fail to cope with channel variations. However, even in the challenging indoor mobile scenario, LTE still manages to keep the error rate below 12%.

### Carrier Aggregation Monitoring Using NG-Scope

Accurate determination of congested cell status requires that a UE be aware of the instantaneous carrier aggregation configuration. The following description shows non-limiting examples of how the carrier aggregation tracking ability of embodiments of the invention, e.g., NG-Scope, can be used in commercial LTE networks.

### Carrier Aggregation Load-Balancing

Understanding how carrier aggregation affects data delivery provides insights for designing an LTE-compatible congestion control algorithm that utilizes embodiments of the invention. Therefore, the following description shows how data are load-balanced over different cells to the UE with carrier aggregation. In this experiment, the UE is static. LTE aggregates three cells (cell one as a primary cell, cell four as a secondary cell, and five as a tertiary cell) for the UE. A remote server sends UDP traffic at different speeds to the UE for five seconds, then the number of data bits each cell tower delivers to the UE is counted and the average transmitted data rate of each cell is calculated. For comparison, the received data rate from the socket interface of the UE is also recorded.

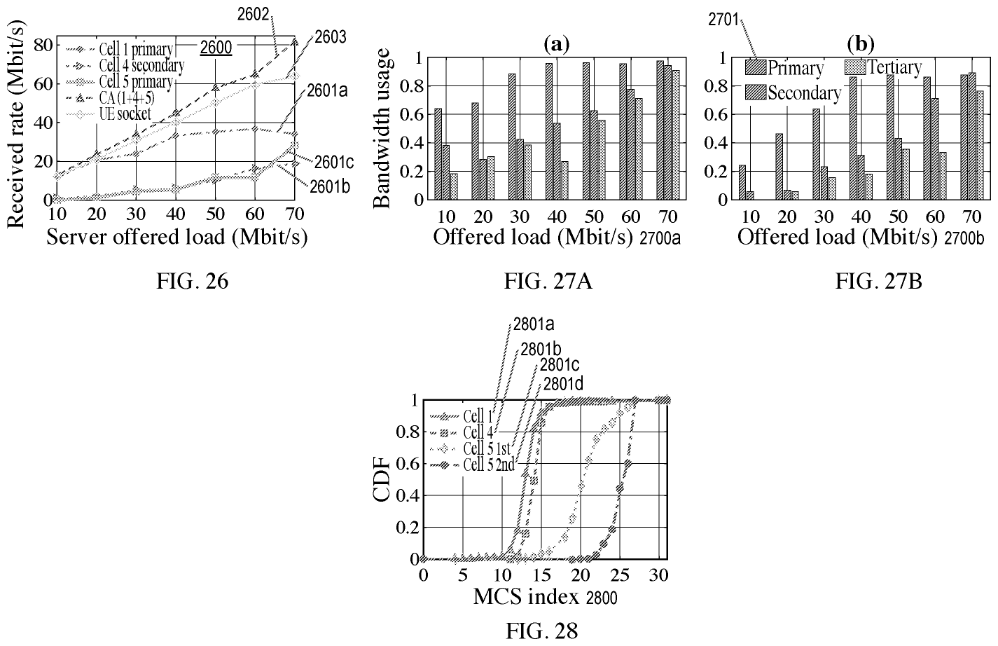

FIG. 26 is a graph 2600 of the received data rate from each of three cells 2601a, 2601b, and 2601c and an aggregation all of the cells 2602, measured using an embodiment of the invention. Graph 2600 also shows the rate at which data is received at the UE socket 2603. The following observations can be made from graph 2600. First, the aggregated rate 2602 (summation of three cells) is larger than the received data rate from the UE's socket 2603 because of protocol overhead and retransmission of erroneous TBs. This matches the relationship shown in graph 1902 in FIG. 19B. Secondly, the cellular network mainly uses the primary cell for data delivery until it is saturated.

FIG. 27A is a plot 2700a of the bandwidth usage percentage, i.e., the ratio of allocated PRBs to the total amount of PRBs, of the cell as function of offered load. FIG. 27B is a plot 2700b of the bandwidth usage percentage of the UE as a function of offered load. The three cells are shown as bars of different colors identified by key 2701. It is shown that the primary cell gets saturated (bandwidth usage close to one) earlier (40 Mbit/s) than the other two aggregated cells (70 Mbit/s).

Returning to FIG. 26, is the plot 2600 shows that when all cells are saturated at 70 Mbit/s, cell five 2601c, with a bandwidth of 5 MHz, supports a similar PHY data rate as cell one 2601a, with a bandwidth of 20 MHz, and a much higher data rate than cell four 2601b, with a bandwidth of 10 MHz.

FIG. 28 is a plot 2800 of the cumulative distribution functions of the modulation coding scheme index each cell 2801a-d, of FIG. 26, uses to transmit data to the UE. Plot 2800 shows that cell five uses two spatial streams 2801c, 2801d and that the MCS used in each spatial stream 2801c-d are much larger than the other two cells 2801a and 2801b. This means that cell five 2801c, 2801d actually has better signal quality and higher spectral efficiency than cell one 2801a and four 2801b. Such a phenomenon indicates the inefficiency of the LTE load balancing algorithm with carrier aggregation. On the one hand, LTE prefers transmitting data to the UE via the primary cell 2801a. On the other hand, the primary cell 2801a may not be the one with the highest signal quality within the aggregated cells. Instead of always saturating the primary cell first 2801a, a load balancing algorithm that selects the cell for data transmission according to the channel quality of each aggregated cell would significantly improve overall spectral efficiency. The granular telemetry data and information provided by embodiments of the invention, such as the data shown in FIGS. 26-28, would be able to support the implementation of such a load balancing algorithm.

### Competing Traffic

In the following description, it is investigated how competing traffic affects load balancing. In a non-limiting experiment, a server transmits data to a Samsung S8 with a constant offered load of 40 Mbit/s and another server transmits to a Xiaomi MIX3 with offered load varying from 30 Mbit/s to 60 Mbit/s (each for five seconds) and stopping for four seconds between each transmission. The two phones connect to the same primary cell (20 MHz) but different secondary and tertiary cells (if applicable). Specifically, the network aggregates a 10 MHz secondary and a 5 MHz tertiary cell for Samsung S8, and a 10 MHz secondary cell Xiaomi MIX3.

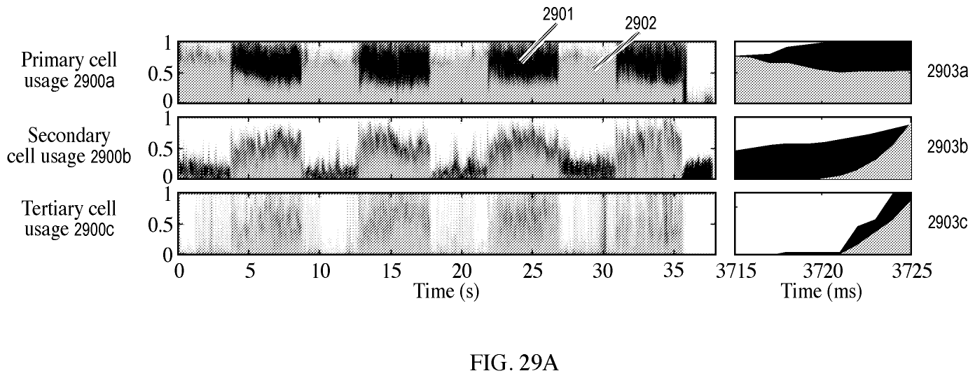

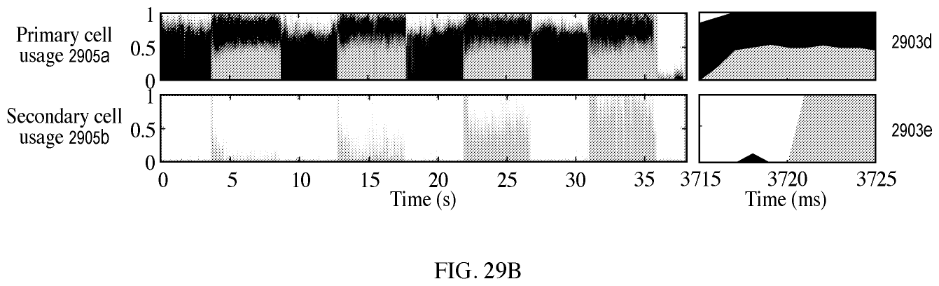

FIG. 29A is a set of graphs showing the channel usage of primary (cell 1) 2900a, secondary (cell 4) 2900b, and tertiary (cell 5) 2900c cells of the Samsung S8. FIG. 29B is a set of graphs showing the channel usage of the primary (cell 1) 2905a and secondary (cell 3) 2905b cells of Xiaomi MIX3. A single cell serves as both primary cell 2900a for the Samsung S8 and primary cell 2905a for the MIX3.

In FIG. 29A the black area 2901 represents the overall channel usage of the cell. The yellow area 2902 represents the usage of mobile phones. It can be observed that when there is no competing traffic from the MIX3, most of the data for the S8 are delivered via the primary cell 2900a. When the competing traffic starts, the primary cell 2900a is saturated. When the competing traffic is over, all the traffic for S8 is shifted back to the primary cell 2900a. Inserts 2903a, 2903b, 2903c, 2903d, and 2903e show a detailed view of graphs 2900a, 2900b, 2900c, 2905a and 2905b, respectively, during the 10 ms period after the starting of competing traffic. It is shown that the channel sharing in the primary cell (2900a and 2905a) and traffic offloading in secondary (2900b and 2905b) and tertiary cells (2900c) are triggered within a few milliseconds, motivating the fine-grain physical layer information that example embodiments of the invention provide. From FIG. 29B, it is shown that since the primary cell 2905a is shared with the S8, increasing the offered load for MIX3 only increases the channel usage in the secondary cell 2905b.

From this experiment, it is demonstrated that the impact of competing traffic in one cell (shown in graph 2900a for the S8 and graph 2905a for the MIX3) could propagate to other cells via carrier aggregation. Such a cross-cell traffic correlation makes the resource allocation of each cell highly dynamic, resulting in significant link capacity variations. With the fine-grain information provided by embodiments of the invention, the UE can track these variations and make responsive actions.

Capacity Tracking with CLAW

The following description compares the accuracy of an example embodiment of the invention's (“NG-Scope”) capacity tracking with CLAW. CLAW implements a capacity tracker based on MobileInsight. Differently from NG-Scope, MobileInsight reports the PRB allocation for a single user, not the full PRB usage of the entire base station. CLAW, therefore, proposes to estimate the PRB usage based on the power measurements reported by MobileInsight, with the intuition that higher utilization results in higher received power. An evaluation of the performance of CLAW's PRB estimation and capacity estimation was performed.

### Methodology Of Capacity Tracking With CLAW

Two mobile users associated with the same base station (20 MHz and 100 PRBs) were put at one indoor and one outdoor location. CLAW was implemented on both mobile devices and logged the estimation of the PRB utilization of every subframe. NG-Scope implementing devices were co-located with CLAW users for comparison. Another three NG-Scope implementing device were deployed at three different locations to estimate the PRB usage of the same base station and extract the PRB usage of subframes where four NG-Scope devices have exactly the same decoding results, as the ground truth.

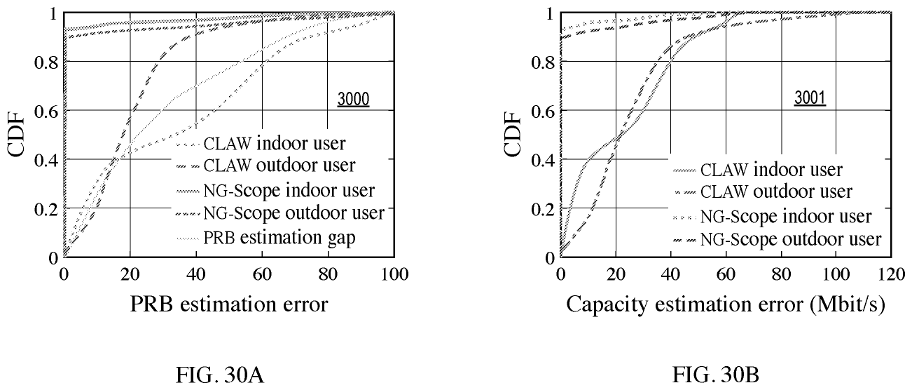

FIG. 30A is a graph 3000 of the CDF of the PRB estimation error for CLAW and an example embodiment of the invention located indoors and outdoors. FIG. 30B is a graph 3001 of the CDF of the capacity estimation error for CLAW and an example embodiment of the invention located indoors and outdoors. It can be observed that CLAW has a much larger error in estimating utilized PRBs than NG-Scope. NG-Scope is accurate in estimation for 92% and 88% of subframes for outdoor and indoor users respectively. CLAW, however, has a median and 95-percentile error of 17 PRBs and 38 PRBs for the outdoor user, and 33 PRBs and 74 PRBs for the indoor user, respectively. The underlying reason for such a large estimation error is that the power measurements are vulnerable to interference of neighboring base stations that operate at the same frequency band and, thus, become quite noisy. Consequently, the PRB estimation based on such a noisy power report is unreliable. Furthermore, CLAW works better if all the PRBs have similar received power at the mobile user. Such an assumption is invalid in an indoor scenario due to the frequency selective fading and, as such, a much higher estimation error for the indoor user is observed.

Additionally, graph 3001 shows that on average, CLAW has an RMS capacity error of 31 Mbit/s, which is 3.3 more than that of NG-Scope's 9.2 Mbit/s. The indoor CLAW user has a larger PRB error, but a similar capacity error due to its lower signal strength.

### Bottleneck Detection With BurstTracker

The follow description compares an example embodiment of the invention's performance with BurstTracker on the task of detecting whether the cellular link is the bottleneck of a connection. The cellular link becomes the bottleneck when all the bandwidth of the base station is fully utilized. BurstTracker is a dedicated tool built atop of MobileInsight for such a task. MobileInsight reports only the PRB allocation for the mobile device it is implemented on and, as such, MobileInsight cannot be directly applied to determine the bottleneck. To bypass such a constraint, BurstTracker makes a hypothesis about the base station's resource allocation algorithm, namely, that a cell tower allocates all the bandwidth to one user in one subframe, evoking the TDMA. However, the experimental results produced a different phenomenon. Specifically, from FIG. 17A, it can be seen that a 20 MHz base station serves and, thus, allocates PRBs to more than one user in 47.5% of the active subframes. Based on such a hypothesis, BurstTracker identifies the start of cellular wireless link becoming a bottleneck, when MobileInsight reports more than 90% of PRB occupation by this user.

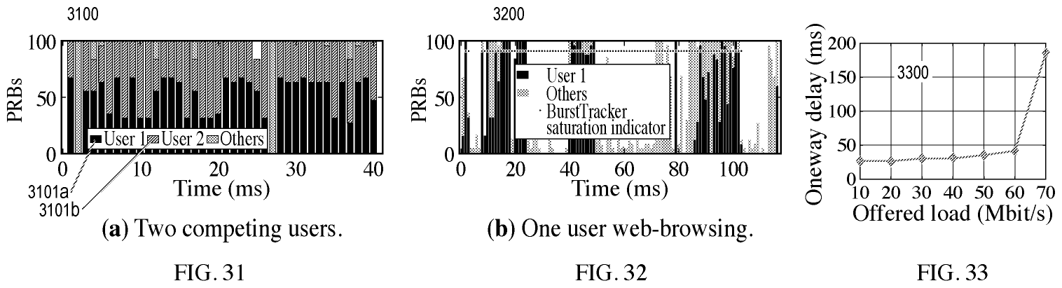

FIG. 31 is a plot 3100 of the PRB allocation results of every subframe measured by an embodiment of the invention. The plot 3100 shows that two users 3101a and 3101b almost equally share the 100 PRBs of the base station, and there is no subframe in which one user occupies more than 90% of the PRBs. On the other hand, almost all the PRBs of this cell are fully utilized, so the cellular wireless link is indeed the bottleneck for both users 3101a-b. This trace is fed to BurstTracker and BurstTracker detects no saturation because the utilization of each user stays around 50%. The cell shares the PRBs inside each subframe (represented by a single bar) among multiple backlogged users, so BurstTracker detects no saturation when it in fact exists.

FIG. 32 is a graph 3200 of the PRB allocation for one web browsing user over time. BurstTracker's method to identify the end of wireless saturation relies on a relatively slow decreasing traffic load, i.e., a subframe with less than 40% PRBs allocated for the user, immediately followed by an empty subframe for that user. However, it can be observed that the end of wireless saturation in a significant amount of traces does not exhibit such a traffic pattern. The plot 3200 in FIG. 32 shows that BurstTracker indicates that there exists a long saturation period that lasts for around 100 ms. However, if the PRB allocation results are checked, it is revealed that the cell tower has multiple idle intervals during the saturation period indicated by BurstTracker. BurstTracker erroneously identifies those idle intervals as saturated because the PRB allocation for the user does not end as required by BurstTracker. Specifically, the PRBs allocated for the user abruptly become zero after a subframe with more than 90% of PRBs allocated. Detecting the wireless link saturation is an easy task for embodiments of the invention with the overall cell bandwidth usage decoded from the control channel. For example, FIG. 27A shows that three aggregated cells are saturated with offered load 70 Mbit/s so that the LTE wireless link becomes the bottleneck.

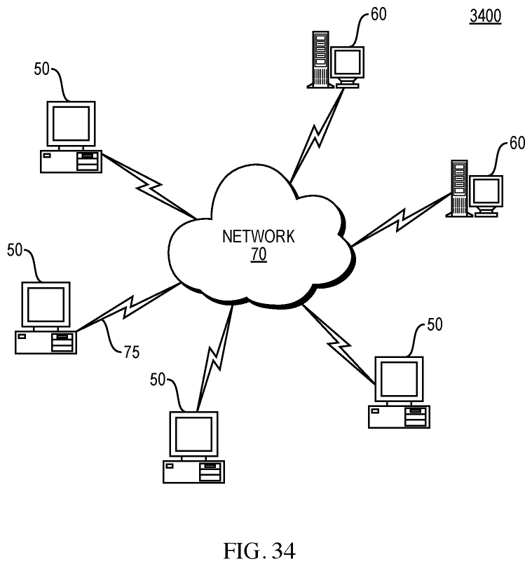

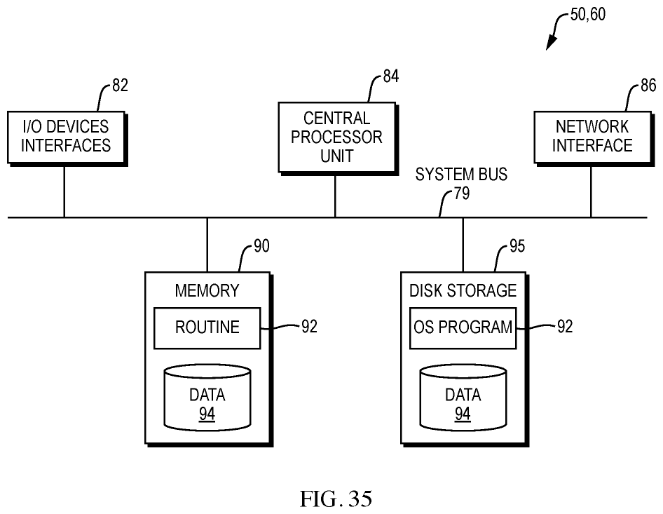

FIG. 33 is a graph 3300 of the one-way delay as a function of offered load varying from 10 Mbit/s to 70 Mbit/s. The plot 3300 of FIG. 33 shows that the average delay is constantly small with offered load from 10 Mbit/s to 60 Mbit/s. The average delay suddenly increases to 185 ms, which is caused by the packet buffering at the base station. BurstTracker was run with 200 traces when the user is conducting different activities, including file downloading, video streaming, and web browsing, and the length of the saturation period in each trace was recorded. The channel usage was measured from NG-Scope as ground truth. The results showed that 42% of the time BurstTracker identified a channel as saturated, the channel was truly saturated and the rest of the time a channel was identified as saturated, 58% of the time, it was a false positive. BurstTracker cannot identify the start and end of LTE link saturation correctly and robustly, due to its invalid hypothesis of all-or-nothing resource allocation, and its requirement of a slowly decreasing traffic load. While these heuristics sometimes do function as intended, the fundamental reason that forces BurstTracker to rely on such heuristics is that BurstTracker can only extract the PRB allocation results for the current user, and not the resource usage of the whole cell. In contrast embodiments of the invention, due to their ability to decode all control messages, are able to determine PRB allocations for all users of the cell.

### Video Streaming And Video Telephony

The capacity of an end-to-end connection is required by ABR algorithms of video streaming applications and video codecs of videotelephony applications, to perform real-time video resolution selection. These systems either rely on the capacity reported by the transport layer protocols or directly derive the capacity based on coarse-grained historical statistics about video delivery at the application layer and, thus, cannot track the fast varying capacity in cellular networks. The detailed capacity information provided by embodiments of the invention can be utilized to improve the function of the ABR algorithms and video codecs.

### Telemetry At Base Station

Embodiments of the invention can be used to perform network telemetry at the mobile devices. Alternative embodiments can collect the millisecond-granular capacity information at the base station. For any end-to-end applications, the base station is a third-party, so the telemetry data collected by the base station cannot be trusted without proper authentication. Building an authentication system between the base station and every end-to-end application that runs atop of it involves significant overhead. Transmitting the telemetry data from the base station back to the mobile devices, however, incurs tremendous communication overhead. For example, if one would like to update the capacity at the same frequency as embodiments of the invention provides, then the base station has to send 1000 messages to each mobile user every second. Even if the frequency is lowered to every 20 ms (which results in delayed reactions), the base station still needs to transmit 50 messages per second per user. Considering the number of UEs a base station serves, the total number of messages the base station sends will be quite large. Based on the above analysis, performing telemetry at the mobile devices is a better choice, at the cost of slightly increased computation overhead for each mobile user.

### Time Division Duplexing (TDD)

Some embodiments of the invention focus on decoding the control channel of the cellular network that adopts FDD in its physical layer. The main difference between TDD and FDD is the frame architecture. Specifically, FDD uses separate frequencies for uplink and downlink channels, while TDD leverages the same frequency band for both uplink and downlink. It is noted that the structure of downlink subframes where the physical control channel resides is identical in TDD and FDD. Therefore, embodiments of the invention are directly applicable to TDD for decoding control messages and monitoring capacity.

### Evolving Cellular Architecture

The design of the physical control channel changes with evolution of the cellular network architecture, from 4G LTE to 5G and 5G beyond. For example, the physical control channel of 5G NR and 4G LTE differs in the following three aspects: (i) 5G NR encodes the physical control messages using polar codes instead of convolutional code, (ii) the location of the control channel inside each subframe does not follow the configuration of 4G LTE as shown in FIG. 3A, and (iii) the formats of the control message, i.e., the meaning of each bit inside a message, are different for 4G LTE and 5G.

However, two important design choices of the physical control channel still remain in the 5G NR and will keep staying in the 3GPP standards for the foreseeable future. First, 5G NR does not encrypt the control messages they transmit so that each mobile user is capable of decoding all the control messages if they choose to. Secondly, 5G NR carries the ID of the mobile devices, i.e., the C-RNTI, inside the control message via XOR-ing it with the CRC. According to the above disclosure, with necessary customization to cope with the changes in the 5G control channel, embodiments of the invention are able to decode all the control messages inside the control channel of the 5G network and associate each decoded message with its ID. Based on the decoded 5G control messages, embodiments of the invention are, therefore, capable of estimating the 5G network capacity, as demonstrated for 4G LTE.

Embodiments of the invention set new benchmarks for accuracy in mobile cellular network monitoring and enable the development of dramatically improved congestion control algorithms and applications that respond more effectively to fluctuations in the wireless channel.

### Digital Processing Environment

FIG. 34 illustrates a computer network 3400 or similar digital processing environment in which embodiments, for non-limiting example, N-G scope, may be implemented. Client computer(s)/devices 50 and server computer(s) 60 provide processing, storage, and input/output devices executing application programs and the like. Client computer(s)/devices 50 and server computer(s) 60 may be parts of systems 400, 1200 and/or be mobile devices (UE) that receive signals. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

FIG. 35 is a diagram of the internal structure of a computer (e.g., client processor/device 50 or server computers 60) in the computer system of FIG. 34. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. 34). Memory 90 provides volatile storage for computer software instructions 92 and data 94 used to implement embodiments of the invention (e.g. NG-Scope 410, decoder 411, worker 406, fusion layer 407, transport layer 408, application layer 409), and the algorithms and methods disclosed herein). Disk storage 95 provides non-volatile storage for computer software instructions 92 and data 94 used to implement many embodiments. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the programs are a computer program propagated signal product 75 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method to identify network properties, the method comprising:
receiving, at a computing device, a cellular signal including one or more control messages formed by a plurality of control channel elements, wherein each control message is formed of one or more of the plurality of control channel elements and each control message is encoded using a function, a respective associated cyclic redundancy check, and a respective unknown temporary identifier;
for each control message:
identifying the one or more of the plurality of control channel elements forming the control message;
deriving, based upon the identified one or more of the plurality of control channel elements, candidate calculated cyclic redundancy checks;
deriving candidate temporary identifiers using the function, the candidate calculated cyclic redundancy checks, and the respective associated cyclic redundancy check;
determining the respective unknown temporary identifier from amongst the derived candidate temporary identifiers; and
decoding the control message using the function, the determined respective unknown temporary identifier, and the respective associated cyclic redundancy check, wherein the decoded control message indicates network properties.

2. The method of claim 1 wherein the computing device is a primary computing device and the one or more control messages are transmitted to one or more secondary computing device distinct from the primary computing device.

3. The method of claim 1 wherein each respective unknown temporary identifier is a 16-bit cell radio network temporary identifier.

4. The method of claim 1 wherein the function is an exclusive or (XOR) function.

5. The method of claim 1 wherein the plurality of control channel elements are distributed within a control channel comprising a section of the cellular signal.

6. The method of claim 5 wherein the plurality of control channel elements are two-dimensional subsections of the control channel defined by time and frequency.

7. The method of claim 1 wherein identifying the one or more of the plurality of control channel elements forming the control message comprises:
measuring respective energy of each of the plurality of control channel elements; and
determining that a control channel element of the plurality of control channel elements with a measured respective energy below a threshold does not form the control message.

8. The method of claim 1 wherein identifying the one or more of the plurality of control channel elements forming the control message comprises:
organizing the plurality of control channel elements into a binary tree hierarchy; and
determining that one or more control channel elements represented by a child node, of a parent node in the binary tree hierarchy, do not form the control message if one or more control channel elements represented by the parent node do not form the control message.

9. The method of claim 1 wherein deriving, based upon the identified one or more of the plurality of control channel elements, the candidate calculated cyclic redundancy checks comprises:
decoding the control message using the identified one or more of the plurality of control channel elements; and
calculating the cyclic redundancy checks using the control message decoded.

10. The method of claim 1 wherein determining the respective unknown temporary identifier from amongst the derived candidate temporary identifiers comprises:
performing at least one of: child-ancestor matching, temporal user tracking, search space matching, and verifying re-encoded errors.

11. The method of claim 1 wherein the network properties include at least one of: channel quality, allocated channel bandwidth, number of active mobile users, total used bandwidth, and idle bandwidth.

12. The method of claim 1 wherein the cellular signal is a Long-Term Evolution (LTE) signal.

13. The method of claim 1 further comprising:
monitoring, using a transport layer of the computing device, the received cellular signal to determine packet statistics of the cellular signal; and
combining the determined packet statistics and the network properties to determine congestion of the network.

14. The method of claim 13 further comprising:
reporting the determined congestion of the network to an application layer of the computing device; and
controlling, by the application layer, use of the network by the computing device based on the reported determined congestion.

15. A computer based system to identify network properties, the system comprising:
a receiver configured to receive, a cellular signal including one or more control messages formed by a plurality of control channel elements, wherein each control message is formed of one or more of the plurality of control channel elements and each control message is encoded using a function, a respective associated cyclic redundancy check, and a respective unknown temporary identifier;
a processor; and
a memory with computer code instructions stored thereon, the processor and the memory, with the computer code instructions being configured to cause the system, for each control message, to:
identify the one or more of the plurality of control channel elements forming the control message;
derive, based upon the identified one or more of the plurality of control channel elements, candidate calculated cyclic redundancy checks;
derive candidate temporary identifiers using the function, the candidate calculated cyclic redundancy checks, and the respective associated cyclic redundancy check;
determine the respective unknown temporary identifier from amongst the derived candidate temporary identifiers; and
decode the control message using the function, the determined respective unknown temporary identifier, and the respective associated cyclic redundancy check, wherein the decoded control message indicates network properties.

16. The system of claim 15 wherein, in determining the respective unknown temporary identifier from amongst the derived candidate temporary identifiers, the processor and the memory, with the computer code instructions, are further configured to cause the system to:
perform at least one of: child-ancestor matching, temporal user tracking, search space matching, and verifying re-encoded errors.

17. The system of claim 15 wherein the network properties include at least one of: channel quality, allocated channel bandwidth, number of active mobile users, total used bandwidth, and idle bandwidth.

18. The system of claim 15 wherein the cellular signal is a Long-Term Evolution (LTE) signal.

19. The system of claim 15 wherein the processor and the memory, with the computer code instructions, are further configured to cause the system to:
monitor, using a transport layer, the received cellular signal to determine packet statistics of the cellular signal; and
combine the determined packet statistics and the network properties to determine congestion of the network.

20. A computer program product for identifying network properties, the computer program product comprising:
one or more non-transitory computer-readable storage devices and program instructions stored on at least one of the one or more storage devices, the program instructions, when loaded and executed by a processor, cause an apparatus associated with the processor to:
receive a cellular signal including one or more control messages formed by a plurality of control channel elements, wherein each control message is formed of one or more of the plurality of control channel elements and each control message is encoded using a function, a respective associated cyclic redundancy check, and a respective unknown temporary identifier;
for each control message:
identify the one or more of the plurality of control channel elements forming the control message;
derive, based upon the identified one or more of the plurality of control channel elements, candidate calculated cyclic redundancy checks;
derive candidate temporary identifiers using the function, the candidate calculated cyclic redundancy checks, and the respective associated cyclic redundancy check;
determine the respective unknown temporary identifier from amongst the derived candidate temporary identifiers; and
decode the control message using the function, the determined respective unknown temporary identifier, and the respective associated cyclic redundancy check, wherein the decoded control message indicates network properties.
